(19) United States
(12) Patent Application Publication
(10) Pub. No.: US 2025/0265523 A1
(43) Pub. Date: Aug. 21, 2025

(54) WORKFLOW CREATION SUPPORT DEVICE AND METHOD

(71) Applicant: Hitachi, Ltd., Tokyo (JP)

(72) Inventor: Tomohiro WATANABE, Tokyo (JP)

(21) Appl. No.: 18/816,077

(22) Filed: Aug. 27, 2024

(30) Foreign Application Priority Data
Feb. 21, 2024 (JP) 2024-024678

(51) Int. Cl. G06Q 10/0631

(52) U.S. Cl. CPC G06Q 10/06316

(57) ABSTRACT

A workflow creation support device and method capable of reducing labor and time required for creating a workflow are proposed. In a workflow creation support method executed by a workflow creation support device that supports creation of a workflow including a plurality of tasks and a workflow creation support method executed by the workflow creation support device, definition contents of a workflow created in the past are managed, and a task candidate of a step to be targeted in the workflow being created is extracted and recommended on the basis of definition contents of a predetermined number of steps of previous and/or subsequent tasks already defined in the workflow being created and definition contents of the existing workflow being managed.

### CROSS-REFERENCE TO RELATED APPLICATION

The present application claims priority from Japanese application JP2024-024678, filed on Feb. 21, 2024, the content of which is hereby incorporated by reference into this application.

### TECHNICAL FIELD

The present invention relates to a workflow creation support device and method, and is suitably applied to, for example, a workflow creation support device that supports creation of a complicated workflow.

### BACKGROUND ART

In general, in operation management of an IT service that manages a computer system, if work content and a work procedure are not prepared, work becomes dependent on individuals, and work efficiency may be reduced. As a method for preventing such personalization of operation management, conventionally, a method has been widely used in which a workflow that defines in advance a work processing procedure such as work content and order is created, and work is performed according to a flow of the created workflow. According to the operation management method using the workflow, there is an advantage that it is possible to clarify the flow of the work and prevent the work from being personified, and the work can be efficiently advanced.

Note that, as a conventional technique regarding creation and review of a workflow, for example, PTL 1 discloses an operation automation support system configured to determine whether there is a shortage of work items in the created workflow, and add the missing work item when there is the shortage.

In addition, PTL 2 discloses an operation system configured to execute a registered operation procedure on a target server to be operated, store an execution result as execution history information, analyze the stored execution history information, transmit information indicating an improvement point in an operation procedure an administrator device on the basis of an analysis result, analyze mutually similar patterns of the registered operation procedures, and transmit information prompting control of the operation procedure to the administrator device on the basis of the analyzed similar patterns.

### CITATION LIST

### Patent Literature

PTL 1: JP 2012-248085 A
PTL 2: JP 2014-191568 A

### SUMMARY OF INVENTION

### Technical Problem

Incidentally, in the workflow, when the flow becomes complicated, it becomes difficult to write and set each parameter. For this reason, there is a problem that it takes a lot of labor and time to create a workflow for a person who does not have specialized knowledge.

The same applies to the improvement of the workflow, and for example, even if an improvement point as disclosed in PTL 2 is indicated, there is a problem that it is not possible to specifically know how to improve the operation procedure, causing a result that much labor and time are required for improvement.

The present invention has been made in view of the above points, and an object of the present invention is to propose a workflow creation support device and method capable of reducing labor and time required for creating a workflow.

### Solution to Problem

In order to solve such a problem, in the present invention, a workflow creation support device that supports creation of a workflow including a plurality of tasks includes: a management unit that manages definition contents of a workflow created in the past; and a candidate task recommendation unit that extracts and recommends a task candidate of a step to be targeted in the workflow being created, on the basis of definition contents of a predetermined number of steps of previous and/or subsequent tasks already defined in the workflow being created and definition contents of the existing workflow managed by the management unit.

In addition, in the present invention, a workflow creation support method executed by a workflow creation support device that supports creation of a workflow including a plurality of tasks includes: a first processing step of managing definition contents of a workflow created in the past; and a second processing step of extracting and recommending a task candidate of a step to be targeted in the workflow being created, on the basis of definition contents of a predetermined number of steps of previous and/or subsequent tasks already defined in the workflow being created and definition contents of the existing workflow being managed.

According to the workflow creation support device and method of the present invention, it is possible to recommend an appropriate task already defined for an administrator who is creating a workflow.

### Advantageous Effects of Invention

According to the present invention, it is possible to realize a workflow creation support device and method capable of reducing labor and time required for creating a workflow.

### BRIEF DESCRIPTION OF DRAWINGS

FIG. 1 is a block diagram illustrating an overall configuration of a workflow creation support system according to an embodiment.

FIG. 2 is a diagram illustrating a configuration of a workflow creation screen.

FIG. 3 is a diagram illustrating a state of screen transition of a workflow creation screen according to an administrator operation.

FIG. 4 is a diagram illustrating a state of screen transition of the workflow creation screen according to the administrator operation.

FIG. 5 is a diagram illustrating a state of screen transition of the workflow creation screen according to the administrator operation.

FIG. 6 is a diagram illustrating a state of screen transition of the workflow creation screen according to the administrator operation.

FIG. 7 is a diagram illustrating a state of screen transition of the workflow creation screen according to the administrator operation.

FIG. 8 is a diagram illustrating a configuration of an operation record registration screen.

FIG. 9 is a conceptual diagram for explaining a prediction method of a task to be designated next.

FIG. 10 is a conceptual diagram for explaining a prediction method of a task to be designated next.

FIGS. 11A to 11B FIG. 11A is a conceptual diagram for explaining a prediction method of a next task using a second-order Markov model, and FIG. 11B is a table for explaining a specific example of the prediction method.

FIG. 12 is a diagram for explaining a method of calculating an evaluation value of a task.

FIGS. 13A to 13B FIG. 13A is a conceptual diagram for explaining a prediction method of a next task using a second-order Markov model, and FIG. 13B is a table for explaining a specific example of the prediction method.

FIG. 14 is a table for explaining parameters of a task.

FIG. 15 is a table for explaining contents that can be designated as a parameter value of a parameter “action”.

FIG. 16 is a diagram for explaining a task classification method.

FIGS. 17A to 17D FIGS. 17A to 17D are conceptual diagrams illustrating a procedure of the task classification method.

FIG. 18 is a table illustrating configuration example of a task table.

FIG. 19 is a table illustrating a configuration example of a task classification table.

FIG. 20 is a table illustrating a configuration example of a workflow table.

FIG. 21 is a table illustrating a configuration example of a person-in-charge table.

FIG. 22 is a table illustrating a configuration example of a cloud execution environment table.

FIG. 23 is a table illustrating a configuration example of a workflow execution history table.

FIG. 24 is a table illustrating a configuration example of a task execution history table.

FIG. 25 is a flowchart illustrating a processing procedure of task classification processing.

FIG. 26 is a flowchart illustrating a processing procedure of task recommendation processing.

FIG. 27 is a flowchart illustrating a processing procedure of workflow registration processing.

FIG. 28 is a flowchart illustrating a processing procedure of workflow time/cost prediction processing.

FIG. 29 is a flowchart illustrating a processing procedure of workflow analysis processing.

FIG. 30 is a sequence diagram illustrating a flow of processing regarding creation/registration of a workflow.

FIG. 31 is a sequence diagram illustrating a flow of processing regarding task recommendation.

FIG. 32 is a sequence diagram illustrating a flow of processing regarding workflow analysis.

FIG. 33 is a sequence diagram illustrating a flow of processing regarding workflow writing.

FIG. 34 is a sequence diagram illustrating a flow of processing regarding workflow execution.

FIG. 35 is a sequence diagram illustrating a flow of processing regarding confirmation of an operation status.

FIG. 36 is a sequence diagram illustrating a flow of processing regarding registration of an operation record.

### DESCRIPTION OF EMBODIMENTS

Hereinafter, an embodiment of the present invention will be described in detail with reference to the drawings.

### (1) Configuration of Workflow Creation Support System According to Present Embodiment

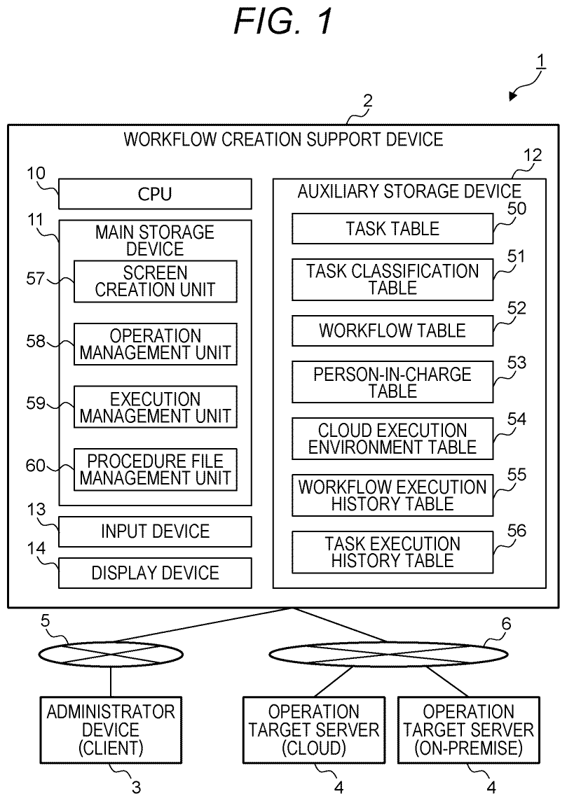

In FIG. 1, reference numeral 1 indicates a workflow creation support system as a whole according to the present embodiment. The workflow creation support system 1 includes a workflow creation support device 2, an administrator device 3, and an operation target server 4.

The workflow creation support device 2 includes a general-purpose server device including a central processing unit (CPU) 10, a main storage device 11, an auxiliary storage device 12, an input device 13, a display device 14, and the like.

The CPU 10 is a processor that controls the operation of the entire workflow creation support device 2. In addition, the main storage device 11 includes a volatile semiconductor memory such as a static random access memory (SRAM) or a dynamic random access memory (DRAM), and is used as a working memory of the CPU 10.

The auxiliary storage device 12 includes, for example, a large-capacity nonvolatile storage device such as a hard disk device or a solid state drive (SSD), and stores data, programs, and the like that need to be stored for a long period of time. The program stored in the auxiliary storage device 12 is read into the main storage device 11 at the time of activation of the workflow creation support device 2 or when necessary, and the CPU 10 executes the program read into the main storage device 11, thereby executing various types of processing of the entire workflow creation support device 2 as described later.

The input device 13 includes, for example, a keyboard, a mouse, and the like, and is used by the administrator to input necessary information and commands to the workflow creation support device 2. In addition, the display device 14 includes, for example, a liquid crystal display, an organic electro-luminescence (EL) display, or the like, and is used to display necessary information and a screen. Note that a touch panel in which the input device and the display device are integrated may be applied instead of the input device 13 and the display device 14.

The administrator device 3 includes a general-purpose computer device such as a notebook personal computer, a disk top personal computer, or a tablet, and is connected to the workflow creation support device 2 via a first network 5 such as the Internet, a local area network (LAN), or a dedicated line. The administrator device 3 transmits various instructions and various types of data input by the administrator of the workflow creation support system 1 to the workflow creation support device 2 via the first network 5, and displays the processing results like of various types of processing or the like transmitted from the workflow creation support device 2 via the first network 5.

In addition, the operation target server 4 is a general-purpose cloud server device or an on-premises server device to which a workflow created by an administrator using the workflow creation support device 2 as described later is applied, and is connected to the workflow creation support device 2 via a second network 6 such as the Internet, a LAN, or a dedicated line. Note that the first and second networks 5 and 6 may be the same network.

### (2) Workflow Creation Support Function According to Present Embodiment

### (2-1) Outline of Workflow Creation Support Function According to Present Embodiment

Next, the workflow creation support function mounted on the workflow creation support device 2 will be described. In the workflow creation support system 1, the administrator can create a new workflow (hereinafter, this is referred to as a new workflow) by sequentially designating a task of each step of the workflow. At this time, the workflow creation support function is a function of extracting and recommending a designated task candidate of the new workflow from tasks used in the past case workflow on the basis of the definition content of the previous and/or subsequent tasks already defined in the new workflow and the definition content of the workflow (hereinafter, this is referred to as a past case workflow) of the past case.

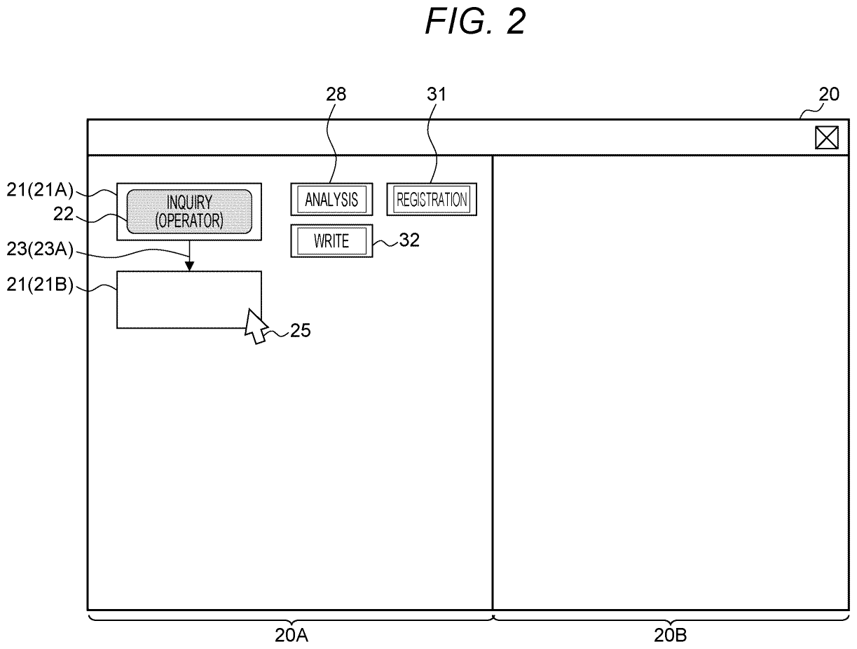

In practice, in the workflow creation support system 1, the administrator can display, on the administrator device 3, a workflow creation screen 20 including a workflow creation area 20A and a recommendation area 20B as illustrated in FIG. 2 by performing a predetermined operation on the administrator device 3.

The workflow creation area 20A is an area for creating a new workflow by arranging tasks desired by the administrator in order. In practice, when the creation of the new workflow is started, a task setting field 21 (21A) of the first step is displayed in a blank state at the upper left of the workflow creation area 20A.

Then, when the administrator sets a task of a first step of the new workflow to be created at that time by a predetermined operation, an icon 22 indicating a label of the task is displayed in the first task setting field 21 (21A). In addition, in addition to this, a second task setting field 21 (21B) for designating a task of the next step is newly displayed below the first task setting field 21 (21A) in a blank state, and an arrow 23 (23A) directed from the first task setting field 21 (21A) to the task setting field 21 (21B) of the second step is displayed between these two task setting fields 21 (21A, 21B).

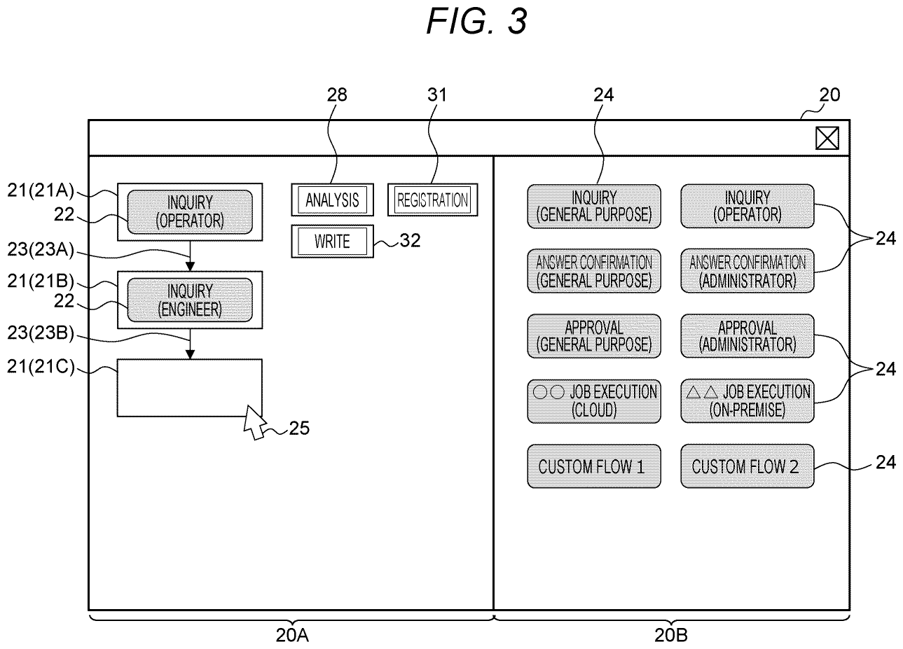

In addition, when the administrator clicks the second task setting field 21 (21B) displayed in the workflow creation area 20A and then sets a task of a second step of the new workflow to be created at that time by a predetermined operation, as illustrated in FIG. 3, the icon 22 indicating a label of the task is displayed in the second task setting field 21 (21B). In addition, in addition to this, a third task setting field 21 (21C) for designating a task of the next step is newly displayed below the second task setting field 21 (21B) in a blank state, and an arrow 23 (23B) directed from the second task setting field 21 (21B) to the third task setting field 21 (21C) is displayed between these two task setting fields 21 (21B, 21C).

Thereafter, when the administrator clicks the third task setting field 21 (21C) displayed in the workflow creation area 20A, several icons 24 each indicating the label of the task recommended by the workflow creation support device 2 as a task of a third step of the new workflow being created at that time are displayed in the recommendation area 20B. Note that a specific selection method of how the workflow creation support device 2 selects a task to be recommended will be described later.

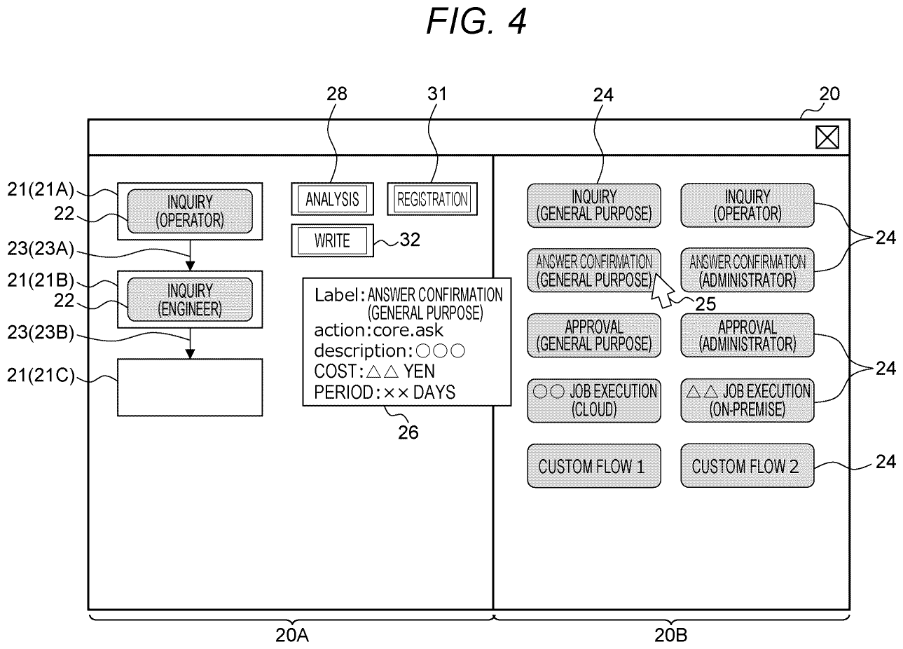

At this time, in the recommendation area 20B, as illustrated in FIG. 4, by moving a cursor 25 onto the icon 24 indicating the label of the desired task among the displayed icons 24, it is possible to display a first pop-up 26 describing the details of the definition content of the task corresponding to the label and the cost and the period required to execute the task. As a result, the administrator can select a task to be applied as a task of the third step among the tasks recommended by the workflow creation support device 2, depending on the information displayed on the first pop-up 26.

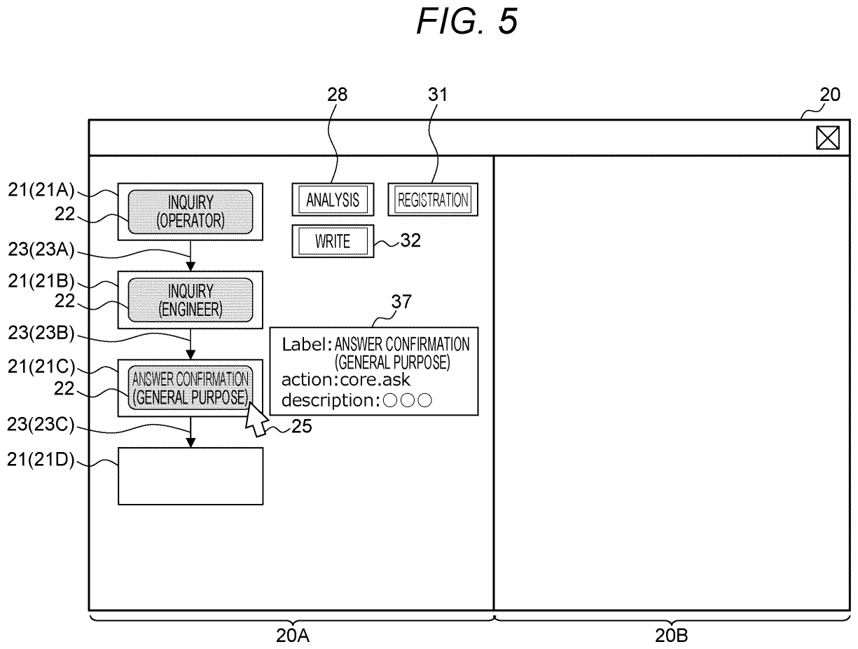

Then, when the administrator moves a label of a task desired as a task of the third step of the new workflow among several tasks for which the icons 24 corresponding to the recommendation area 20B are displayed into the third task setting field 21 (21C) by dragging and dropping, or sets a third task of the new workflow by a predetermined operation similar to the first and second tasks, as illustrated in FIG. 5, the icon 22 indicating the label of the task is displayed in the third task setting field 21 (21C). In addition, in addition to this, a fourth task setting field 21 (21D) for setting a task of the next step is newly displayed below the third task setting field 21 (21C) in a blank state, and an arrow 23 (23C) directed from the third task setting field 21 (21C) to the fourth task setting field 21 (21D) is displayed between these two task setting fields 21 (21C, 21D).

Thereafter, when the administrator clicks the n-th (here, n≥4) task setting field 21 displayed in the workflow creation area 20A on the workflow creation screen 20 in the same manner as described above, one or more icons 24 each indicating a label of a task recommended by the workflow creation support device 2 as a task of the n-th step of the new workflow being created at that time are displayed in the recommendation area 20B.

Then, when the administrator moves the icon 24 of the task desired as a task of the n-th step of the new workflow among several tasks for which the icons 24 corresponding to the recommendation area 20B are displayed into the n-th task setting field 21 by dragging and dropping or sets the n-th task of the new workflow by a predetermined operation similar to the first task, the icon 22 indicating the label of the task is displayed in the n-th task setting field 21. In addition, an (n+1)-th task setting field 21 for designating the next task is newly displayed below the n-th task setting field 21 in a blank state, and an arrow 23 directed from the n-th task setting field 21 to the (n+1)-th task setting field 21 is displayed between these two task setting fields 21.

Thus, by repeating the above operation using the workflow creation screen 20, the administrator can sequentially set the task of each step in the new workflow being created at that time, thereby creating a desired new workflow.

Note that, on the workflow creation screen 20, the cursor 25 is moved onto the task setting field 21 of the step in which the task has already been set in the new workflow displayed in the workflow creation area 20A, whereby it is possible to display a second pop-up 27 describing details of the definition content of the task as illustrated in FIG. 5. Then, in this second pop-up 27, the described definition of the task can be edited, so that the definition of the task of the step in the new workflow can also be updated.

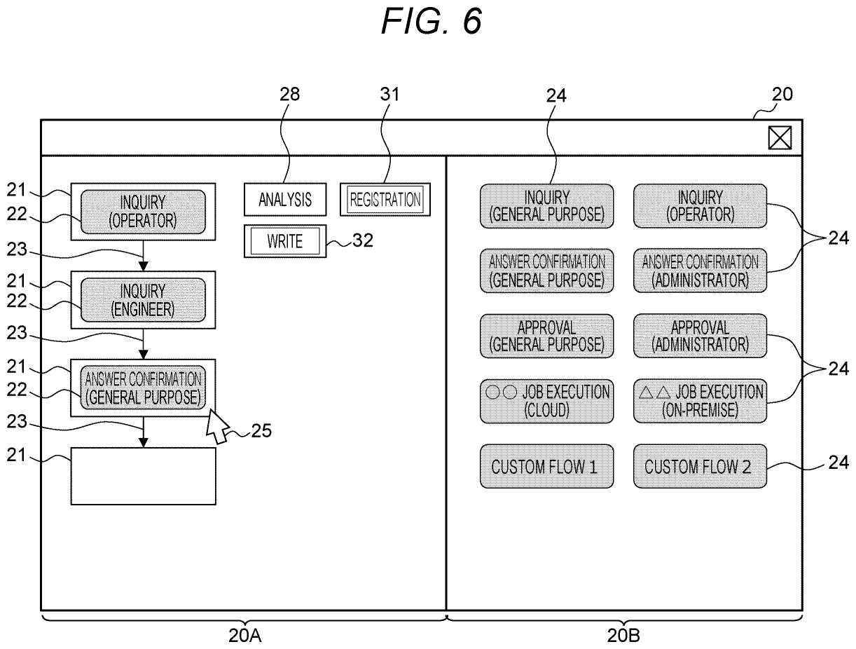

In addition, on the workflow creation screen 20, as illustrated in FIG. 6, when the task setting field 21 of the third and subsequent steps in which the task is already set in the middle of creating the new workflow as described above is clicked, several icons 24 in which labels of the tasks recommended by the workflow creation support device 2 as the tasks of the steps are written can be displayed again in the recommendation area 20B.

Then, when the administrator moves the icon 24 of the task desired as the task of the step of the new workflow from the tasks in which the icon 24 corresponding to the recommendation area 20B is displayed into the corresponding task setting field 21 by dragging and dropping, or sets the task of the step to be changed of the new workflow by a predetermined operation similar to the first task, the icon 22 indicating the label of the task moved or set at that time is written is displayed in the task setting field 21 of the step instead of the label of the original task.

In this case, when the task of the step after the step is not designated, a blank task setting field 21 for setting the task of the next step is displayed below the task setting field 21 of the step, and an arrow 23 directed from the task setting field 21 of the step to the newly displayed next task setting field 21 is displayed between these two task setting fields 21.

On the other hand, when the task of the step after the step is already designated (the task setting field 21 of the next step is already displayed), the task setting field 21 for setting the task of the next step is not newly displayed, and accordingly, the arrow 23 directed from the task setting field 21 of the step to the task setting field 21 of the next step is not newly displayed.

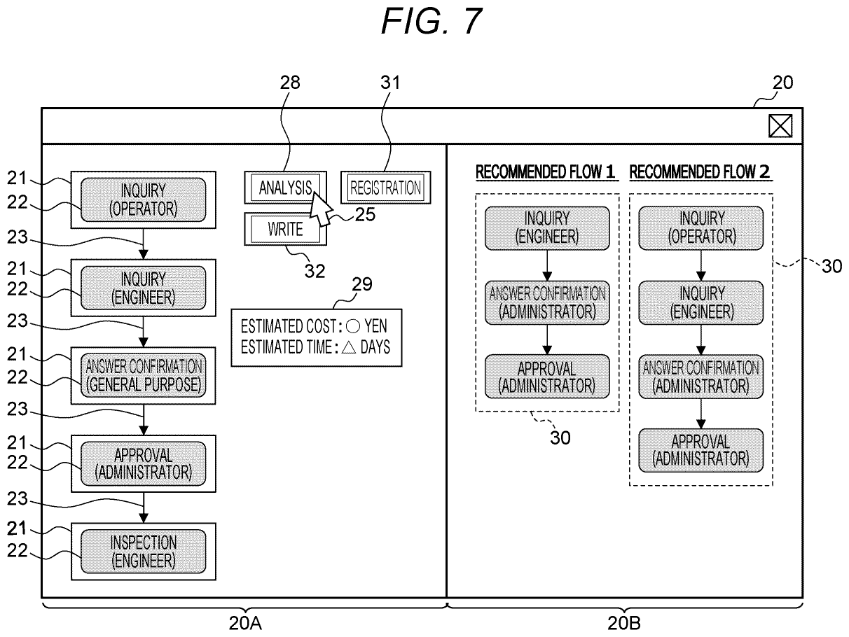

On the other hand, on the workflow creation screen 20, as illustrated in FIG. 7, when a new workflow is created in the workflow creation area 20A as described above, and then the analysis button 28 provided in the workflow creation area 20A is clicked, it is possible to cause the workflow creation support device 2 to predict the cost and time required to execute the new workflow created by the administrator at that time. Hereinafter, the cost required to execute the workflow is referred to as an execution cost, and the time is referred to as an execution time. Then, at this time, a third pop-up 29 in which the execution cost and the execution time predicted by the workflow creation support device 2 are described is displayed on the workflow creation screen 20.

In addition, at the same time, one or more past case workflows similar to the new workflow created by the administrator at that time and recommended by the workflow creation support device 2 are extracted from the workflow (hereinafter, this is referred to as a past case workflow) created in the past and already executed in any of the operation target servers 4 (FIG. 1), and are displayed as the recommended workflow 30 in the recommendation area 20B. As a result, the administrator can update the content of the new workflow created on the workflow creation area 20A as necessary while referring to the recommended workflow 30 displayed in the recommendation area 20B.

In addition, by clicking the registration button 31 on the workflow creation screen 20 after creating a new workflow as described above, various types of information regarding the new workflow can be registered in the workflow creation support device 2. Note that the “various types of information regarding the workflow” here is information indicating the definition of content the workflow (hereinafter, this is referred to as workflow information) including information on the definition content of each task constituting the workflow (hereinafter, this is referred to as task information), information regarding the task classification of these tasks, information on the arrangement order of these tasks, and the like.

Furthermore, when the administrator clicks the write button 32 on the workflow creation screen 20 after creating a new workflow, the workflow information of the new workflow can be converted into a file and output to the workflow creation support device 2. In this case, the workflow information converted into a file is managed in that state in the workflow creation support device 2.

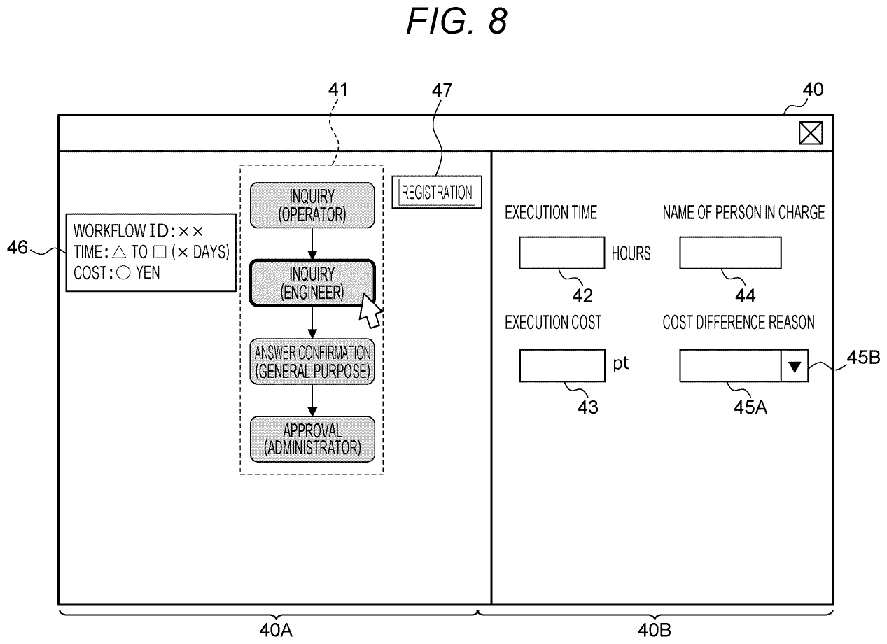

On the other hand, the administrator can display an operation record registration screen 40 as illustrated in FIG. 8 on the administrator device 3 by performing a predetermined operation on the administrator device 3. On the operation record registration screen 40, the workflow (past case workflow) 41 already executed by a predetermined operation can be displayed in a record registration target workflow display area 40A on the left side of the screen. In this case, in addition to the past case workflow 41, a fourth pop-up 46 indicating the workflow ID of the past case workflow 41, and the execution time and the execution cost required to execute the past case workflow is also displayed in the record registration target workflow display area 40A.

Then, on the operation record registration screen 40, when a desired task (hereinafter, this is referred to as a target task) in the past case workflow 41 displayed in the record registration target workflow display area 40A as described above is clicked, the execution time text box 42 for inputting the actual time required to execute the target task and the cost text box 43 for inputting the actual cost required to execute the target task are displayed in a record input area 40B provided on the left side of the operation record registration screen 40.

In addition, at this time, in the record input area 40B, a person-in-charge text box 44 for inputting the name of a person in charge who actually took charge of the target task, a cost difference reason designation field 45A for designating the reason why a difference between the cost predicted by the workflow creation support device 2 and the actual cost required has occurred by a pull-down method, and the like are also displayed.

Thus, the administrator can manually input these pieces of information by inputting the actual time required to execute the target task in the time text box 42, inputting the actual cost required to execute the target task in the cost text box 43, and inputting the name of the person in charge when the target task is actually executed in the person-in-charge text box 44.

Furthermore, the administrator can designate the reason by selecting an appropriate reason as the reason why the difference between the cost predicted by the workflow creation support device 2 and the cost actually required has occurred from the choices written in the pull-down menu (not illustrated) displayed by clicking a pull-down button 45B displayed on the right side of the cost difference reason designation field 45A. The reason designated at this time is displayed in the cost difference reason designation field 45A.

Then, on the operation record registration screen 40, the actual time, cost, and the like required for execution of other tasks of the past case workflow 41 displayed in the record registration target workflow display area 40A are manually input in the same manner as described above, and then the registration button 47 is clicked, so that these pieces of information can be registered as manual input information regarding the past case workflow in the workflow creation support device 2.

### (2-2) Method for Selecting and Displaying Recommendation Task by Workflow Creation Support Device

Next, a specific method of selecting and displaying a task to be recommended to the user in the workflow creation support device 2 will be described.

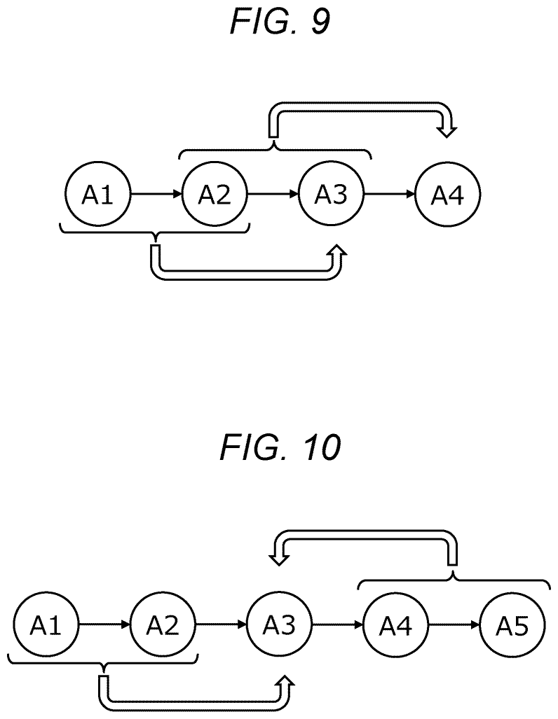

In the case of the present embodiment, the workflow creation support device 2 analyzes the arrangement order of the tasks in the past case workflow by using an N-th order Markov model, estimates several tasks that are likely to be set as the task of the step designated in the new workflow on the basis of the analysis result, and recommends these tasks. Here, it is assumed that for the third and subsequent steps, the workflow creation support device 2 estimates a task that is likely to be set as a task of the steps by using a second-order Markov model (N=2) as illustrated in FIGS. 9 and 10.

In practice, when in the workflow creation area 20A of the workflow creation screen 20 (FIGS. 2 to 7), the n-th task setting field 21 (FIGS. 2 to 7) is clicked in a state where each of the tasks up to (n−1)-th (here, n≥3) in the new workflow is already set, and the n-th and subsequent tasks are not set, the workflow creation support device 2 extracts, from the past case workflow, all the past case workflows in which the tasks of the same task classification as each of the tasks set as the (n−2)-th task and the (n−1)-th task in the new workflow are respectively set as the (n−2)-th task and the (n−1)-th task.

Note that here, the “task classification” is a group of tasks classified according to the definition contents, and the “tasks of the same task classification” refers to tasks that can be handled as tasks of the same task classification although the definition contents do not completely match. For example, in a case where a task of which the label defined by the administrator is “inquiry” and a task of which the label defined by the same administrator is “query” all have the same definition contents other than the label, these tasks can be treated as the same task. Therefore, such two tasks correspond to “tasks of the same task classification”.

Then, the workflow creation support device 2 specifies all the tasks set as the n-th task in each extracted past case workflow, and calculates the appearance probabilities of the respective task classifications to which the specified tasks belong.

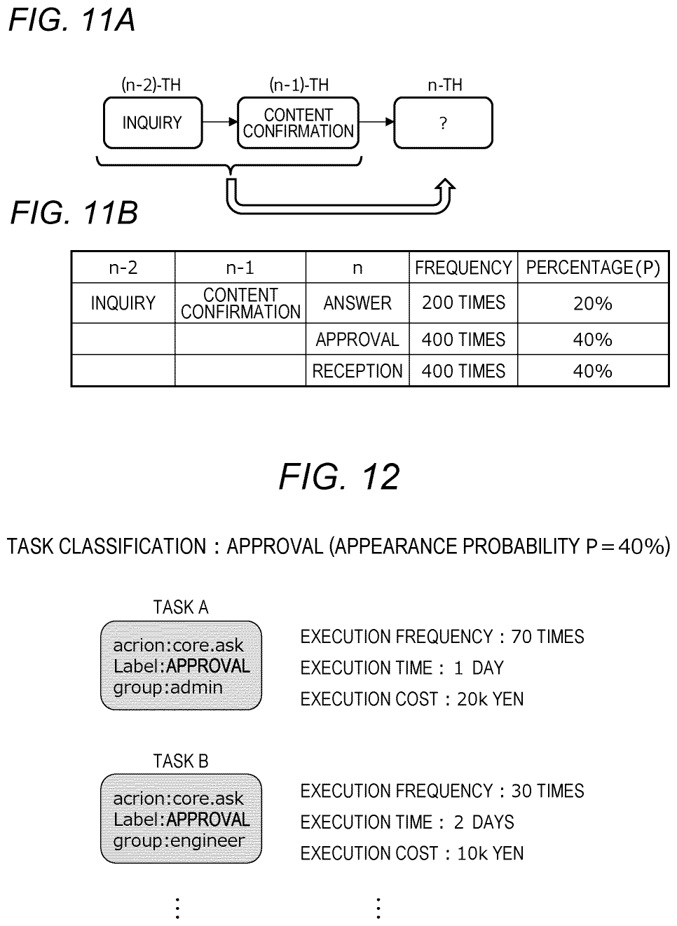

For example, as illustrated in FIG. 11A, it is assumed that the n-th task setting field 21 is clicked in a state where a task having a task classification labeled “inquiry” is designated as the (n−2)-th task in the new workflow by the administrator, and a task having a task classification labeled “content confirmation” is designated as the (n−1)-th task by the administrator.

In this case, the workflow creation support device 2 extracts, from the past case workflows, all the past case workflows in which the (n−2)-th task is set to the task having the same task classification as the (n−2)-th task of the new workflow, and the (n−1)-th task is set to the task having the same task classification as the (n−1)-th task of the new workflow, and specifies the task classification of the n-th task in the extracted past case workflows.

In addition, as illustrated in FIG. 11B, the workflow creation support device 2 counts the appearance frequency for each specified task classification. Then, on the basis of the counting result, the workflow creation support device 2 calculates, by the following equation

$$\begin{matrix}[ Mathematical Formula 1 ] & \\ P = \frac{Appearance frequency of task classification to be targeted}{Total number of extracted past case workflows} & ( 1 )\end{matrix}$$

an appearance probability P for each task classification.

Note that FIG. 11B illustrates an example in which the labels of the n-th set tasks in the extracted past case workflow are three types of “answer”, “approval”, and “reception”, and the appearance frequencies of the tasks for the respective task classifications to which these tasks belong are “200 times”, “400 times”, or “400 times”, respectively, so that the appearance probabilities P of these task classifications are calculated to be “20%”, “40%”, or “40%”, respectively.

Furthermore, as illustrated in FIG. 12, the workflow creation support device 2 extracts, from the tasks constituting each past case workflow, all the tasks belonging to each task classification for which the appearance probability P has been calculated as described above, and calculates the appearance frequency, the execution time, and the execution cost of the extracted tasks on the basis of the execution history of the past case workflow so far. A specific calculation method of the appearance frequency, the execution time, and the execution cost of these tasks will be described later.

Then, on the basis of the calculated appearance frequency, execution time, and execution cost of these tasks, the workflow creation support device 2 calculates, by the following equation

$$\begin{matrix}[ Mathematical Formula 2 ] & \\ S = P \times {\sum }_{k = 0}^{n} {a}_{k} {x}_{k} & ( 2 )\end{matrix}$$

an evaluation value S for each extracted task. Note that, in Equation (2), a is a weight for each viewpoint (appearance frequency, execution time, and execution cost), x is an average value for each viewpoint, and P is an appearance probability of a task classification to which a task to be targeted belongs.

For example, in the case of the example of FIG. 12, the workflow creation support device 2 calculates, by the following equation for “task A”

$$\begin{matrix}[ Mathematical Formula 3 ] & \\ S = 0.4 \times ( {a}_{1} \times 70 + {a}_{2} \times 1 + {a}_{3} \times 20000 ) & ( 3 )\end{matrix}$$

the evaluation value S of the task, and calculates, by the following equation for “task B”

$$\begin{matrix}[ Mathematical Formula 4 ] & \\ S = 0.4 \times ( {a}_{1} \times 30 + {a}_{2} \times 2 + {a}_{3} \times 10000 ) & ( 4 )\end{matrix}$$

the evaluation value S of the task.

Then, the workflow creation support device 2 displays the icons 24 indicating the labels of the tasks in the recommendation area 20B of the workflow creation screen 20, such that the tasks are arranged in the vertical direction such that the task classification having a larger total value of the calculated evaluation values S is positioned higher, and the top several (for example, maximum 2 to 3) tasks having larger evaluation values S in the same task classification are arranged in the horizontal direction (see FIGS. 3, 4, and 6).

On the other hand, in a case where the task setting field 21 corresponding to the n-th task in which each of the (n−2)-th and (n−1)-th tasks and each of the (n+1)-th and (n+2)-th tasks are already designated (that is, a task in which two tasks before and after the task are already set) is clicked, the workflow creation support device 2 selects and displays the task to be recommended as follows.

First, the workflow creation support device 2 extracts, from the past case workflows, all the past case workflows in which tasks of the same task classification as the task classification of the tasks set as the (n−2)-th task and the (n−1)-th task of the new workflow are set as the (n−2)-th task and the (n−1)-th task, respectively.

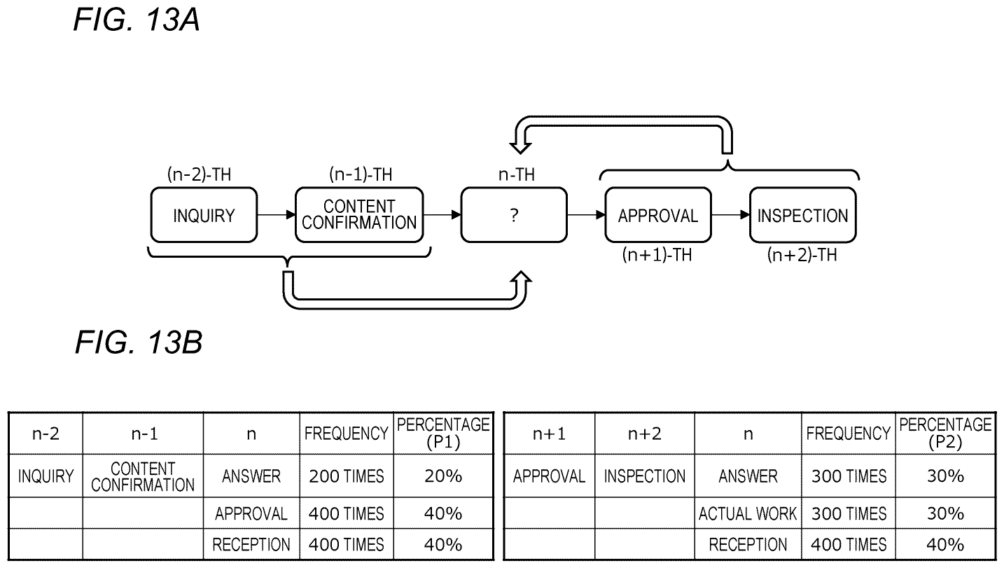

Then, as illustrated in FIGS. 13A and 13B, the workflow creation support device 2 specifies the task classification of the n-th task in each extracted past case workflow and calculates the appearance probability (hereinafter, this is referred to as a first appearance probability) P1 of each of the specified task classifications, similarly to the method described above with respect to FIGS. 11A and 11B.

In addition, the workflow creation support device 2 extracts, from the past case workflows, all the past case workflows in which tasks of the same task classification as the task classification of tasks set as the (n+1)-th and (n+2)-th tasks in the new workflow are set as the (n+1)-th task and (n+2)-th task, respectively.

Then, as illustrated in FIGS. 13A and 13B, the workflow creation support device specifies all the task classifications of the tasks set as the n-th task in each extracted past case workflow and calculates the appearance probabilities (hereinafter, this is referred to as a second appearance probability) P2 for each of the specified task classifications, by the same method as the method described above with respect to FIGS. 11A and 11B.

For example, as illustrated in FIG. 13B, it is assumed that in the new workflow, a task labeled “inquiry” is designated as the (n−2)-th task by the administrator, a task labeled “content confirmation” is designated as the (n−1)-th task by the administrator, a task labeled “approval” is designated as the (n+1)-th task by the administrator, and a task labeled “inspection” is designated as the (n+2)-th task by the administrator, and the task setting field 21 corresponding to the n-th task is clicked.

In this case, the workflow creation support device 2 extracts, from the past case workflows, all the past case workflows in which the (n−2)-th task is set to the task having the same task classification as the task of “inquiry”, and the (n−1)-th task is set to the task having the same task classification as the task of “content confirmation”, and specifies all the task classifications of the n-th task in each extracted past case workflow. In addition, the workflow creation support device 2 calculates the first appearance probability P1 for each specified task classification by Equation (1).

In addition, the workflow creation support device 2 extracts all the past case workflows in which the (n+1)-th task is set to the task of the same task classification as the task of “approval”, and the (n+2)-th task is set to the task of the same k classification as the task of “inspection”, and specifies all the task classifications set as the n-th task in the extracted past case workflows. In addition, the workflow creation support device 2 calculates the second appearance frequency P2 for each specified task classification by Equation (1).

Furthermore, on the basis of the first and second appearance probabilities P1 and P2 calculated as described above for the same task classification, the workflow creation support device calculates, by the following equation

$$\begin{matrix}[ Mathematical Formula 5 ] & \\ P = α \times P 1 + β \times P 2 & ( 5 )\end{matrix}$$

the appearance probability P of the task classification. Note that, in Equation (5), a is a weight for the first appearance probability P1, and β is a weight for the second appearance probability P2.

In addition, the workflow creation support device 2 extracts, from the tasks constituting each past case workflow, all the tasks belonging to each task classification for which the appearance probability P has been calculated as described above, and calculates the appearance frequency, the execution time, and the execution cost of the extracted tasks on the basis of the execution history of the past case workflow.

Furthermore, the workflow creation support device 2 calculates the evaluation value S for each task by the above-described Equation (2) on the basis of the calculated appearance frequency, execution time, and execution cost of these tasks.

Then, the workflow creation support device 2 displays the icons 24 (FIGS. 3, 4, and 6) of the labels of the tasks in the recommendation area 20B of the workflow creation screen 20, such that the tasks are arranged in the vertical direction such that the task classification having a larger total value of the calculated evaluation values S is positioned higher, and the top several (for example, maximum 2 to 3) tasks having larger evaluation values S in the same task classification are arranged in the horizontal direction.

Note that, in the above-described example, a case has been described in which a task that is likely to be designated as a task of an n-th step (n≥3) is estimated by using the second-order Markov model. However, a task that is likely to be set in an n-th step (n≥2) may be estimated in the same manner as described above by using the first-order Markov model (which is an N-th order Markov model with N=1, and is also referred to as a simple Markov model).

Note that the use of the first-order Markov model can also be applied to a case where a task that is likely to be set in the n-th step (n≥2) is estimated by using only a task in a step before the step as illustrated in FIG. 9, and a case where a task that is likely to be set in the n-th step (n≥2) is estimated by using tasks in steps before and after the step as illustrated in FIG. 10.

Furthermore, a task that is likely to be set in the (N+1)-th and subsequent steps may be estimated by using an N-th order Markov model in which N is 3 or more.

### (2-3) Task Classification Method According to Present Embodiment

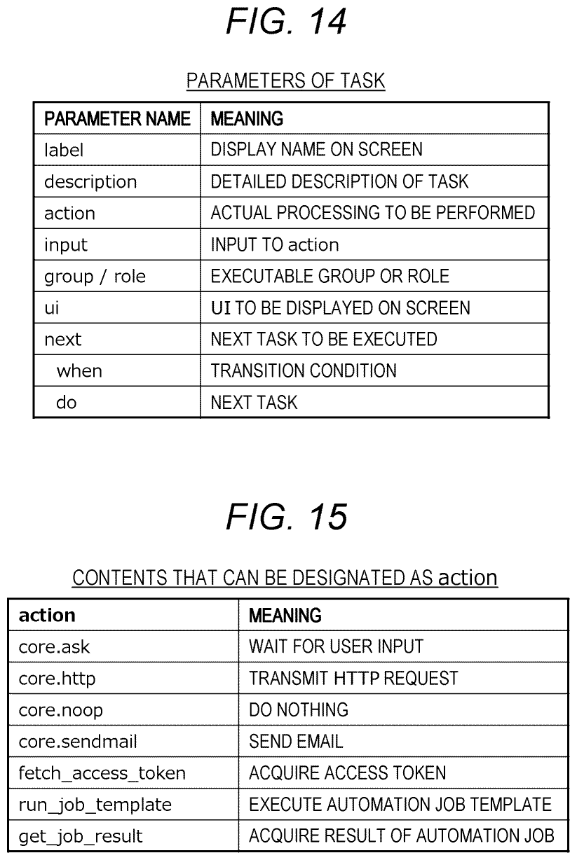

Next, a method in which the workflow creation support device 2 classifies each task of the new workflow into any task classification will be described. In the present embodiment, each task of the new workflow is classified on the basis of the parameter of the task. Here, description will be made assuming that the task is defined by nine parameters of “label”, “description”, “action”, “input”, “group/role”, “ui”, “next”, “when”, and “do” as illustrated in FIG. 14.

Note that “action” is a parameter representing the content of processing actually performed as the task. In the present embodiment, examples of processing that can be designated as the “action” include “core.ask”, “core.http”, “core.noop”, “core.sendmail”, “fetch_access_token”, “run _job_template”, and “get_job_result” as illustrated in FIG. 15.

Here, in a case where a condition that the task to be classified is classified into a certain task classification is set such that all parameters of the task to be classified and all parameters of any task belonging to such a task classification are completely matched, even though the task classification is originally the same, a case where the label (“label”) differs by one character or a case where the sentence of the description of the task in the “description” differs by several characters is also determined to be a task of another classification.

However, the label (“label”) and “description” are defined by the administrator, and depending on the administrator, “inquiry” may be expressed as “query”, “enquiry”, “question”, or the like, or an explanatory sentence of a task in “description” may be expressed differently from the expressions of other administrators although the contents are originally the same. Then, in such a case, when it is determined that the task to be classified does not belong to the task classification, there is a possibility that a problem that the task to be originally recommended is not recommended or the same task is redundantly recommended occurs.

In this regard, in the present embodiment, the task to be classified is classified into an existing or new task classification by the following method.

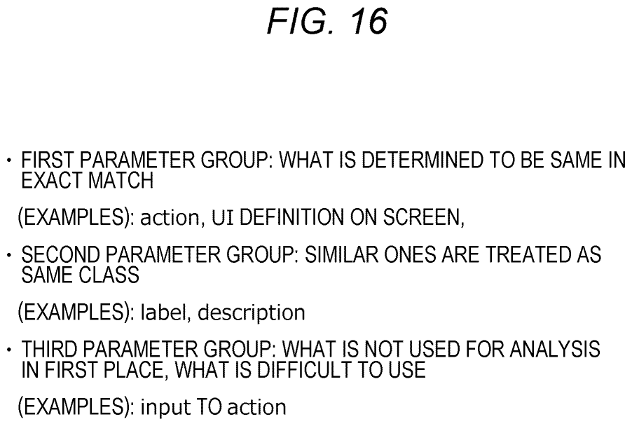

First, as illustrated in FIG. 16, the parameters of the task are divided into a first parameter group including parameters (for example, “action” and “ui”) that is to be determined to be the same in an exact match, a second parameter group including parameters (for example, “label” and “description”) in which similar ones are treated as the same, and a third parameter group including parameters (for example, “input”) that are not used for analysis or are difficult to use. In addition, for each parameter belonging to the first parameter group, a representative value of the parameter in the task classification is set in advance for each task classification.

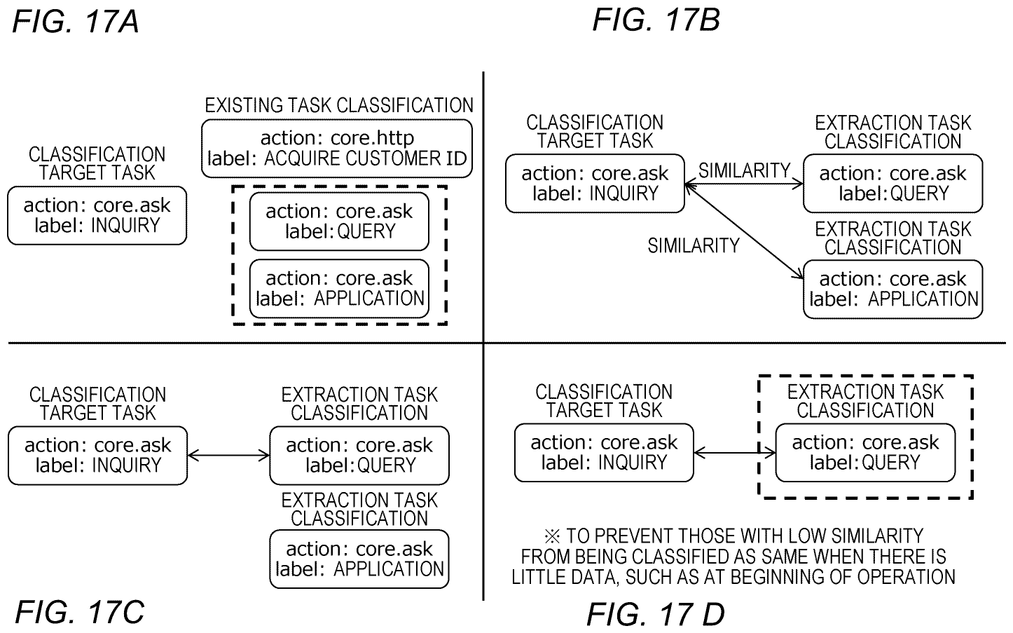

Then, in a case where the task of the new workflow is classified into any task classification, first, as illustrated in FIG. 17A, the values of the parameters belonging to the first parameter group of the task (hereinafter, this is referred to as a classification target task) are compared with the representative values of the parameters in the existing task classification for each existing task classification.

Then, the task classification in which the values of all the parameters belonging to the first parameter group of the classification target task are completely matched with the representative values of the corresponding parameters is extracted. Hereinafter, the task classification extracted at this time is referred to as an extraction task classification.

Subsequently, as illustrated in FIG. 17B, a similarity between the classification target task and each task classification is calculated from the representative value of each parameter belonging to the second parameter group of the classification target task and the representative value of each parameter belonging to the second parameter group of the extraction task classification.

Such a similarity can be calculated as a weighted sum of similarity between words or between sentences for each parameter. Note that, for example, the Levenshtein distance between two words can be the similarity between the two words, and the Word Mover's Distance between two sentences can be the similarity between the two sentences.

Next, as illustrated in FIG. 17C, an extraction task classification having the highest similarity to the classification target task is selected. Furthermore, as illustrated in FIG. 17D, it is determined whether the similarity between the selected extraction task classification and the classification target task is greater than or equal to a preset threshold, and if an affirmative result is obtained, the classification target task is classified into the selected extraction task classification. Note that the determination of FIG. 17D is added in order to prevent the classification target task from being classified into the task classification having a small similarity when there is little data, for example, at the beginning of operation.

### (2-4) Configuration of Workflow Creation Support Device Regarding Workflow Creation Support Function

As means for realizing the workflow creation support function of the present embodiment as described above, as illustrated in FIG. 1, a task table 50, a task classification table 51, a workflow table 52, a person-in-charge table 53, a cloud execution environment table 54, a workflow execution history table 55, and a task execution history table 56 are stored in the auxiliary storage device 12 of the workflow creation support device 2, and a screen creation unit 57, an operation management unit 58, an execution management unit 59, and a procedure file management unit 60 read from the auxiliary storage device 12 are stored in the main storage device 11 of the workflow creation support device 2.

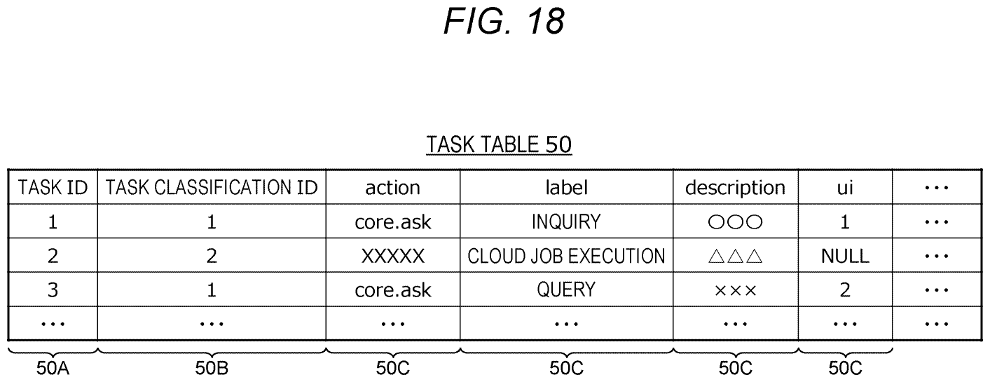

The task table 50 is a table used to manage a task set in any past case workflow, and as illustrated in FIG. 18, includes a task ID field 50A and a task classification ID field 50B, and a parameter value field 50C for each parameter described above with respect to FIG. 14.

In the task table 50, one record (row) corresponds to task information of one task executed in any past case workflow. Note that, in the task table 50, tasks in which the parameter values of the parameters completely match are treated as the same task, and even if these tasks are executed in different past case workflows, the task information of these tasks is not redundantly registered in the task table 50.

Then, an identifier (task ID) assigned to the corresponding task and unique to the task is stored in the task ID field 50A, and an identifier (task classification ID) assigned to the task classification of the classification destination of the task and unique to the task classification is stored in the task classification ID field 50B. In addition, the parameter values of corresponding parameters set for the corresponding tasks are stored in the parameter value fields 50C.

Therefore, in the case of the example of FIG. 18, it is indicated that, for example, a task to which a task ID of “1” is assigned is a task classified into a task classification to which a task classification ID of “1” is assigned, and the parameter value of each parameter is set such that “action” is set to “core.ask”, “label” is set to “inquiry”, “description” is set to “ooo”, and “ui” is set to “1” and so on.

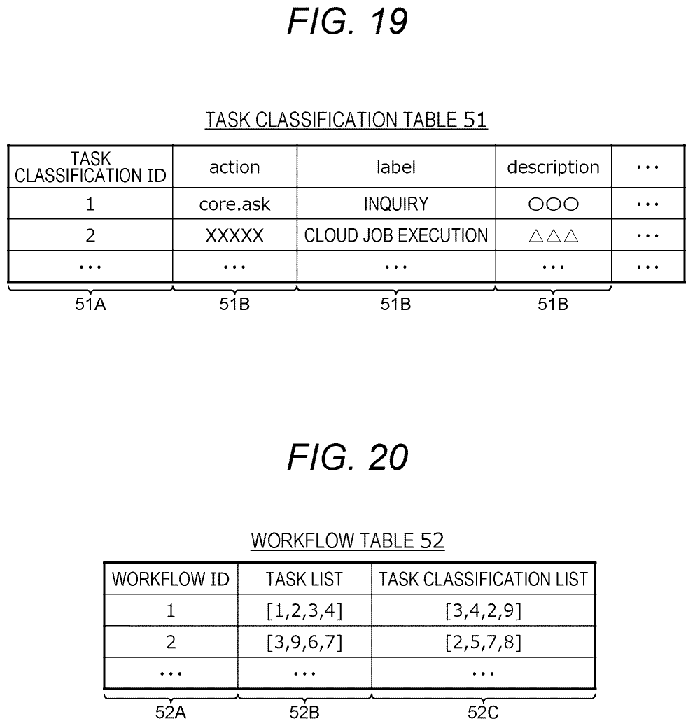

The task classification table 51 is a table for managing representative values of specific parameters of tasks that can be classified into the task classification for each task classification, and as illustrated in FIG. 19, includes a task classification ID field 51A and a plurality of specific parameter fields 51B. In the task classification table 51, one record corresponds to one task classification.

Then, the task classification ID stores a task classification ID of a corresponding task classification. In addition, in each specific parameter field 51B, a representative value (parameter value) of each of several specific parameters for classifying a task into a task classification is stored.

Therefore, in the example of FIG. 19, it is indicated that, for example, in order for a certain task to be classified into a task classification to which a task classification ID of “1” is assigned, the parameter value of “action” needs to be a value that matches or is close to “core.ask”, the parameter value of “label” needs to be a value that matches or is close to “inquiry”, the parameter value of “description” needs to be a value that matches or is close to “ooo”, and so on (since the parameter value is only a representative value).

The workflow table 52 is a table for managing a workflow created in the past (past case workflow), and includes a workflow ID field 52A, a task list field 52B, and a task classification list field 52C as illustrated in FIG. 20. In the workflow table 52, one record corresponds to one past case workflow.

Note that, in the workflow table 52, the past case workflows in which the same task is set in the same order are treated as the same past case workflow, and even if these past case workflows are executed at different timings, information regarding these past case workflows is not redundantly registered in the workflow table 52.

Then, in the workflow ID field 52A, an identifier (workflow ID) assigned to the corresponding past case workflow and unique to the past case workflow is stored, and in the task list field 52B, the task IDs of tasks of steps constituting the past case workflow are stored in a list format in which the task IDs are arranged in step order.

In addition, in the task classification list field 52C, the task classification IDs of the task classifications into which the tasks of the steps in the corresponding past case workflow are classified are stored in a list format in which the task classification IDs are arranged in the step order of the corresponding tasks.

Therefore, in the case of the example of FIG. 20, it is indicated that, for example, the past case workflow to which the workflow ID of “1” is assigned is a workflow in which the tasks to which the task IDs of “1” to “4” are respectively assigned are executed in this order, and the task classifications of the tasks of “1” to “4” are task classifications to which the task classification IDs of “3”, “4”, “2”, or “9” are respectively assigned.

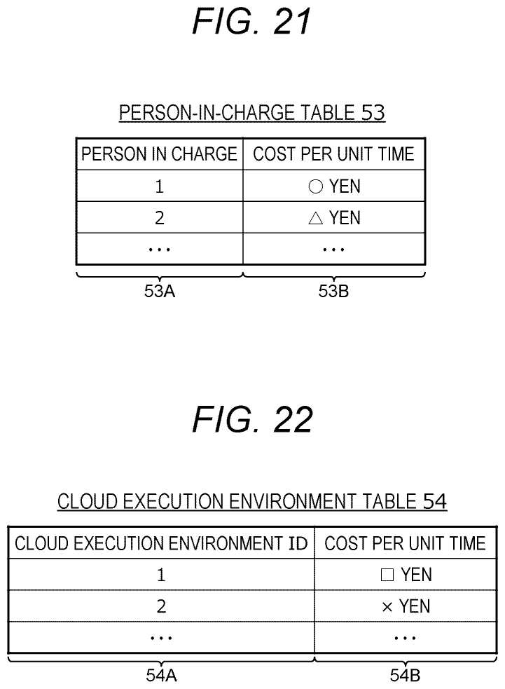

The person-in-charge table 53 is a table for managing a person in charge when the past case workflow is executed or an administrator who can be in charge when the new workflow is executed, and includes a person-in-charge ID field 53A and a cost-per-unit time field 53B as illustrated in FIG. 21. In the person-in-charge table 53, one record corresponds to one person in charge.

Then, in the person-in-charge ID field 53A, an identifier (person-in-charge ID) assigned to the corresponding person in charge and unique to the person in charge is stored, and in the cost-per-unit time field 53B, a cost per unit time of the person in charge is stored. Therefore, in the case of the example of FIG. 21, it is indicated that the cost per unit time of the person-in-charge ID of “1” is “o yen”, for example.

In addition, the cloud execution environment table 54 is a table for managing a cloud environment, and includes a cloud environment ID field 54A and a cost-per-unit time field 54B as illustrated in FIG. 22. In the cloud execution environment table 54, one record corresponds to one cloud environment in which a workflow is executed.

Then, in the cloud environment ID field 54A, an identifier (cloud environment ID) assigned to the corresponding cloud environment and unique to the cloud environment is stored, and in the cost-per-unit time field 54B, a use cost per unit time of the cloud environment is stored. Therefore, in the case of the example of FIG. 22, it is indicated that the use cost per unit time of the cloud environment ID of “1” is “□ yen”, for example.

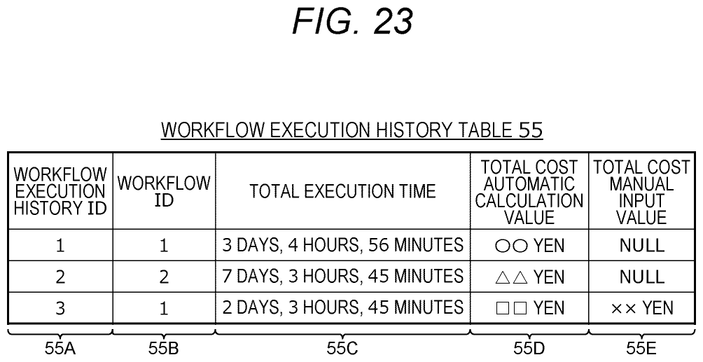

The workflow execution history table 55 is a table for managing the execution history of a workflow, and includes a workflow execution history ID field 55A, a workflow ID field 55B, a total execution time field 55C, a total cost automatic calculation value field 55D, and a total cost manual input value field 55E as illustrated in FIG. 23. In the workflow execution history table 55, one record corresponds to the execution history of one workflow (past case workflow).

Then, in the workflow execution history ID field 55A, an identifier (workflow execution history ID) assigned to the corresponding execution history and unique to the execution history is stored, and in the workflow ID field 55B, the workflow ID of the past case workflow executed at that time is stored.

In addition, in the total execution time field 55C, the total time (total execution time) required to execute the past case workflow is stored, and in the total cost automatic calculation value field 55D, the total cost automatically calculated by the workflow creation support device 2 and required to execute the corresponding past case workflow is stored.

Note that the total execution time of the past case workflow is calculated as the sum of the execution times of the individual tasks constituting the past case workflow, and the total cost of the past case workflow is calculated as the sum of the costs required to execute the individual tasks constituting the past case workflow. A method of calculating the execution time and cost of each task will be described later.

Furthermore, in the total cost manual input value field 55E, the actual total cost manually input by the administrator and required to execute the corresponding past case workflow is stored. Note that in a case where the total cost is not manually input by the administrator, “NULL” is stored in the total cost manual input value field 55E.

Therefore, in the case of the example of FIG. 23, it is indicated that, for example, the execution history of the past case workflow to which the workflow execution history ID of “1” is assigned is the execution history of the past case workflow to which the workflow ID of “1” is assigned, “3 days, 4 hours, and 56 minutes” is required to execute the past case workflow, the total cost is “oo yen” in the automatic calculation by the workflow creation support device 2, and no manual input of the total cost has been performed by the administrator (the value of the total cost manual input value field 55E is “NULL”).

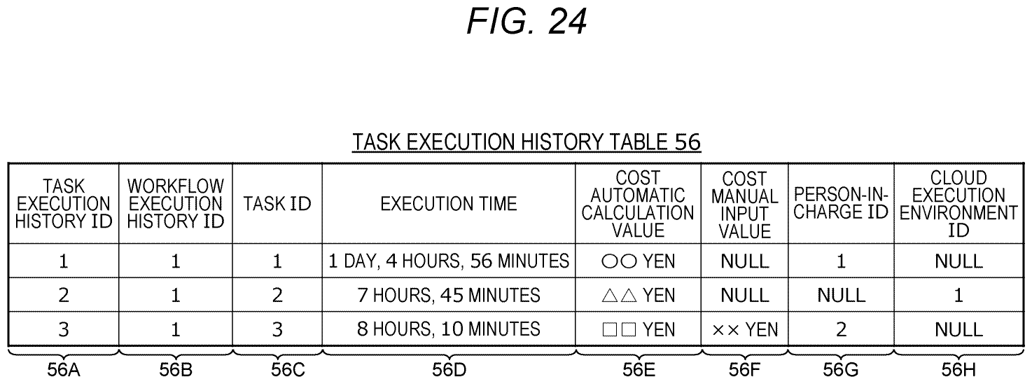

The task execution history table 56 is a table used to manage the execution history of each task constituting the past case workflow, and as illustrated in FIG. 24, includes a task execution history ID field 56A, a workflow execution history ID field 56B, a task ID field 56C, an execution time field 56D, a cost automatic calculation value field 56E, a cost manual input value field 56F, a person-in-charge ID field 56G, and a cloud execution environment ID field 56H. In the task execution history table 56, one record corresponds to the execution history of one task.

Then, in the task ID field 56C, the task ID of the corresponding task is stored, and in the task execution history ID field 56A, an identifier (task execution history ID) assigned to the execution history of the task and unique to the execution history is stored. In addition, in the workflow execution history ID field 56B, the workflow execution history ID of the execution history of the past case workflow in which the task was executed is stored.

In addition, in the execution time field 56D, the time (execution time) required to execute the corresponding task is stored, and in the cost automatic calculation value field 56E, the cost (execution cost) required to execute the task automatically calculated by the workflow creation support device 2 is stored.

Note that an average value of times required to execute the task is applied as the execution time of the task, and an average value of costs required to execute the task is applied as the execution cost of the task. The execution cost of the task can be calculated by adding a value obtained by multiplying the cost per unit time of the corresponding person in charge stored in the person-in-charge table 53 (FIG. 21) by the time required to execute the task and a value obtained by multiplying the cost per unit time of the cloud environment used to execute the task stored in the cloud execution environment table 54 (FIG. 22) by the time required to execute the task.

Furthermore, in the cost manual input value field 56F, the cost manually input by the administrator and required to execute the corresponding past case workflow is stored. Note that in a case where the total cost is not manually input by the administrator, “NULL” is stored in the cost manual input value field 56F. In addition, in a case where a numerical value is stored in the cost manual input value field 56F, the numerical value stored in the cost manual input value field 56F is preferentially used at the time of calculating the value to be input to the total cost automatic calculation value field 55D of the workflow execution history table 55 described above with respect to FIG. 23.

Furthermore, in the person-in-charge ID field 56G, the person-in-charge ID of the person in charge in charge of execution of the corresponding task is stored. Note that, in a case where the task is not manually performed, “NULL” is stored in the person-in-charge ID field 56G.

Furthermore, in the cloud execution environment ID field 56H, the cloud environment ID of the cloud environment in which the corresponding task is executed is stored. Note that in a case where the task is a task that does not use a cloud environment, “NULL” is stored in the cloud execution environment ID field 56H.

Therefore, in the case of the example of FIG. 24, it is indicated that, for example, the task execution history to which the task execution history ID of “1” is assigned is the execution history of the task having the task ID of “1” of the past case workflow corresponding to the workflow execution history to which the workflow execution history ID of “1” is assigned.

In addition, FIG. 24 illustrates that “1 day, 4 hours, and 56 minutes” is required to execute the task, the execution cost is “oo yen” in the automatic calculation by the workflow creation support device 2, and no manual input of the cost has been performed by the administrator (the value of the total cost manual input value field 56F is “NULL”). In addition, FIG. 24 also illustrates that the task was executed by the person in charge to which the person-in-charge ID of “1” is assigned, and the cloud environment was not used (the value of the cloud execution environment ID field 56H is “NULL”).

On the other hand, the screen creation unit 57 is a program having a function of causing the administrator device 3 to display various screens by transferring various requests given from the administrator device 3 to the operation management unit 58 according to the operation of the administrator or generating various screens including the workflow creation screen 20 and the operation record registration screen 40 described above with respect to FIGS. 2 to 8 on the basis of information given from the operation management unit 58, and transmitting the screen data to the administrator device 3.

In addition, the operation management unit 58 is a program having a function of referring to the task table 50, the task classification table 51, the workflow table 52, the person-in-charge table 53, the cloud execution environment table 54, the workflow execution history table 55, and the task execution history table 56 on the basis of a request from the administrator given from the screen creation unit 57, selecting a task or a past case workflow to be recommended to the administrator, and notifying the screen creation unit 57 of the selected task or past case workflow.

In addition, the operation management unit 58 stores and manages various types of information given from the administrator via the screen creation unit 57 and various types of information input via the input device 13 (FIG. 1) in the task table 50, the task classification table 51, the workflow table 52, the person-in-charge table 53, the cloud execution environment table 54, the workflow execution history table 55, or the task execution history table 56.

The execution management unit 59 is a program having a function of causing a new workflow created by the administrator to be executed on the operation target server 4 (FIG. 1) instructed by the administrator in response to an instruction from the operation management unit 58, acquiring an execution result, and notifying the operation management unit 58 of the execution result.

In addition, the procedure file management unit 60 is a program having a function of converting the workflow information of the new workflow created by the administrator into a file and storing the file according to an instruction from the operation management unit 58.

### (3) Various Types of Processing Regarding Workflow Creation Support Function

Next, specific processing contents of various types of processing executed in the workflow creation support device 2 in relation to the workflow creation support function according to the present embodiment will be described. Note that, in the following description, a processing subject of various types of processing will be described as a program (“ . . . unit”), but in practice, it goes without saying that the CPU 10 (FIG. 1) executes the processing on the basis of the program.

### (3-1) Task Classification Processing

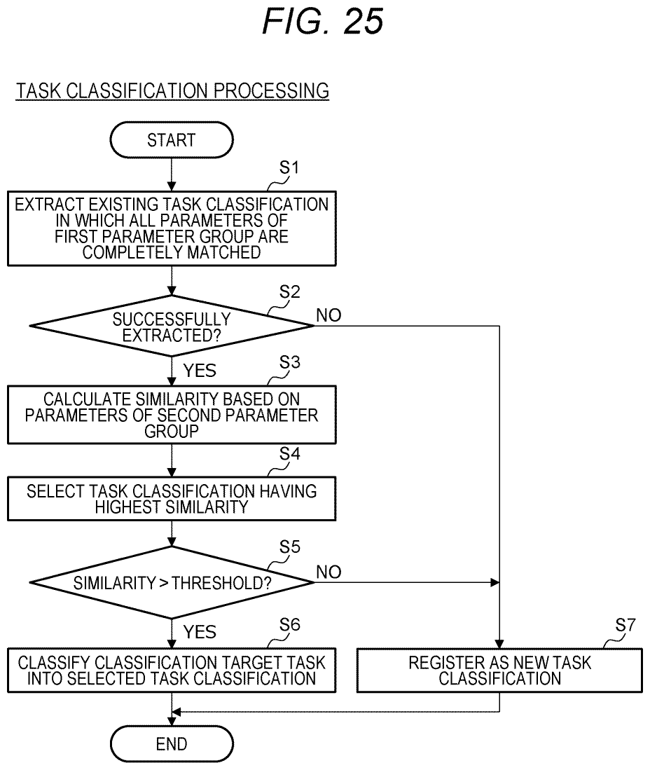

FIG. 25 illustrates a processing procedure of task classification processing executed by the operation management unit 58 when classifying tasks. The operation management unit 58 classifies the task (classification target task) to be classified at that time into any task classification in accordance with the processing procedure illustrated in FIG. 25.

In practice, when the task classification processing is started, the operation management unit 58 first compares the parameter value of each parameter belonging to the first parameter group described above with respect to FIG. 16 of each task classification registered in the task classification table 51 (FIG. 19) with the parameter value of each parameter belonging to the first parameter group of the classification target task, and extracts all existing task classifications in which the parameter values of all the parameters belonging to the first parameter group match (S1).

Subsequently, the operation management unit 58 determines whether at least one task classification has been extracted in step S1 (S2). Then, if a negative result is obtained in this determination, the operation management unit 58 determines that there is no existing task classification to which the classification target task is applicable, and registers a necessary parameter of the classification target task as a parameter of a new task classification in the task classification table 51 (S7). Thereafter, the operation management unit 58 ends the task classification processing.

On the other hand, if an affirmative result is obtained by the determination in step S2, the operation management unit 58 calculates the similarity between each extraction task classification and the target task as described above, on the basis of the parameter value of each parameter belonging to the second parameter group of each task classification (extraction task classification) extracted in step S1 and the parameter value of each parameter belonging to the second parameter group of the classification target task, the parameter value being registered in the task classification table 51 (S3).

Subsequently, the operation management unit 58 selects one extraction task classification having the highest similarity to the classification target task on the basis of the similarity between each extraction task classification calculated in step S3 and the classification target task (S4), and determines whether the similarity is larger than a preset threshold (S5).

Then, if a negative result is obtained in this determination, the operation management unit 58 classifies the classification target task into the extraction task classification selected in step S4, and then, ends the task classification processing.

### (3-2) Task Recommendation Processing

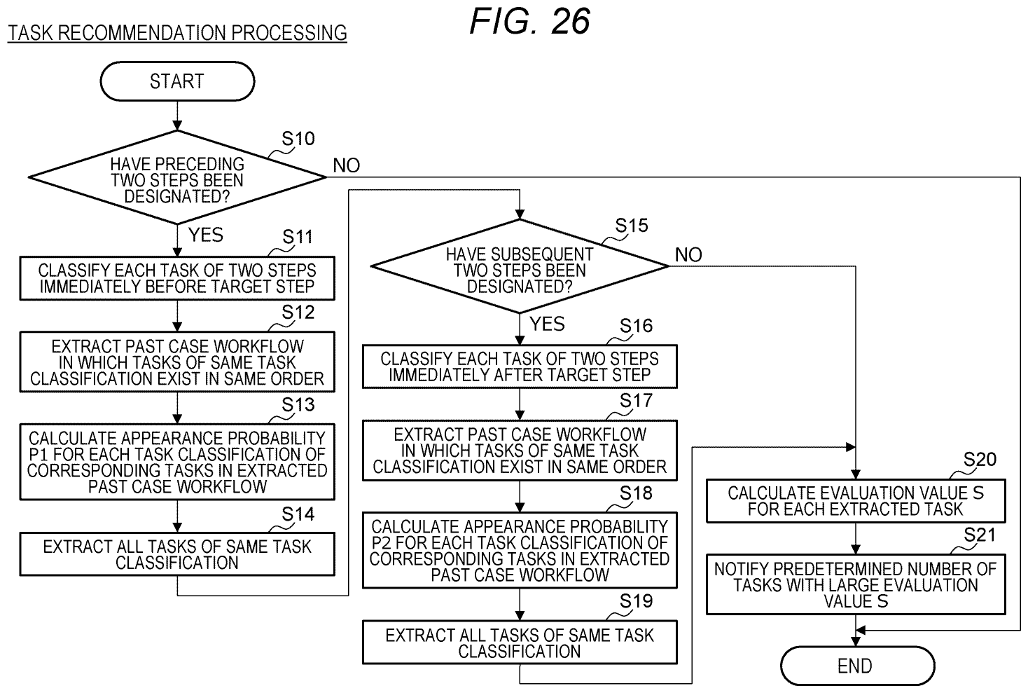

FIG. 26 illustrates a processing procedure of the task recommendation processing executed by the operation management unit 58 when the workflow creation support device 2 recommends a task while the administrator is creating a new workflow. In accordance with the processing procedure illustrated in FIG. 26, the operation management unit 58 extracts a task candidate of a step designated by the administrator and recommends the task candidate to the administrator.

In practice, for example, when the task setting field 21 (FIGS. 2 to 7) of any step (hereinafter, this is referred to as a target step) is clicked while the administrator is creating a new workflow by using the workflow creation screen 20, the operation management unit 58 starts the task recommendation processing illustrated in FIG. 26.

Then, the operation management unit 58 first determines whether the tasks of two steps immediately before the target step in the new workflow have already been set (S10). Then, if a negative result is obtained in this determination, the operation management unit 58 ends the task recommendation processing. Therefore, in this case, the task recommended as the task of the target step by the workflow creation support device 2 is not displayed in the recommendation area 20B (FIGS. 2 to 7) of the workflow creation screen 20.

On the other hand, if an affirmative result is obtained in the determination of step S10, the operation management unit 58 classifies each task into any task classification by executing the task classification processing described above with respect to FIG. 25 for each task in the two steps immediately before the target step (S11).

Subsequently, on the basis of the classification result in step S11, the operation management unit 58 extracts, from the workflow table 52, all the past case workflows in which tasks of the same task classification as the task classification of each task of the two steps immediately before the target step in the new workflow exist in the same order (S12).

Specifically, the operation management unit 58 refers to the task classification list 52C (FIG. 20) of the workflow table 52, and extracts all the workflow IDs of the past case workflows in which the same task classification as the task classification of each task of the two steps immediately before the target step in the new workflow exists in the same order.

Next, the operation management unit 58 refers to the task classification list field 52C of the workflow table 52, specifies the task classification of the task of the step corresponding to the target step of the new workflow in each past case workflow (hereinafter, this is referred to as a first extracted past case workflow) extracted in step S12, and calculates the appearance probability P1 for each specified task classification by the method described above with respect to FIGS. 11A and 11B (S13).

Furthermore, the operation management unit 58 extracts all the tasks belonging to each task classification specified in step S13 (S14). Specifically, the operation management unit 58 extracts all the task IDs in which the task classification IDs of the task classifications specified in step S13 are stored in the task classification ID field 50B of the task table 50 (FIG. 18).

Subsequently, the operation management unit 58 determines whether each task of two steps immediately after the target step in the new workflow has already been set (S10). Then, if a negative result is obtained in this determination, the operation management unit 58 proceeds to step S20.

On the other hand, if an affirmative result is obtained in the determination of step S15, the operation management unit 58 classifies each task into any task classification by executing the task classification processing described above with respect to FIG. 25 for each task of the two steps immediately after the target step (S16).

In addition, similarly to step S12, on the basis of the classification result of step S16, the operation management unit 58 extracts, from the workflow table 52, all the past case workflows in which the same task classification as the task classification of each task of the two steps immediately after the target step in the new workflow exists in the same order (S17).

Furthermore, the operation management unit 58 refers to the task classification list field 52C of the workflow table 52, specifies the task classification of the task of the step corresponding to the target step of the new workflow in each past case workflow (hereinafter, this is referred to as a second extracted past case workflow) extracted in step S12, and calculates the appearance probability P2 for each specified task classification by the method described above with respect to FIGS. 11A and 11B (S18).

Furthermore, similarly to step S14, the operation management unit 58 extracts all the tasks belonging to each task classification specified in step S18 (S19).

Thereafter, the operation management unit 58 calculates the evaluation value S for each task extracted in step S14 and/or step S19 (S20).

Specifically, if a negative result is obtained in the determination in step S15, and the process proceeds to step S20, the operation management unit 58 calculates the evaluation value S of each task extracted in step S14 by the above-described Equation (2). Note that, in this case, the appearance probability P1 calculated in step S13 is P in Equation (2).

In addition, if the process proceeds to step S20 through step S19, the operation management unit 58 calculates the evaluation value S of each task extracted in steps S14 and S19 by the above-described Equation (2). In this case, the appearance probability P is calculated by Equation (5) on the basis of the appearance probability P1 calculated in step S13 and the appearance probability P2 calculated in step S18, and then the evaluation value S of each task is calculated by Equation (2).

Furthermore, the operation management unit 58 notifies the screen creation unit 57 (FIG. 1) of the tasks extracted in step S14 and step S19 and the task classifications of the tasks, and the evaluation value S for each task calculated in step S20 (S21), and then ends the task recommendation processing.

Thus, thereafter, the screen creation unit 57 generates the workflow creation screen 20 in which the icons 24 indicating the labels of the tasks are displayed in the recommendation area 20B such that the tasks are arranged in the vertical direction such that the task classification having a larger total value of the evaluation values S is positioned higher, and the top several (for example, maximum 2 to 3) tasks having larger evaluation values S in the same task classification are arranged in the horizontal direction, and t transmits the screen data to the corresponding administrator device 3, thereby displaying the workflow creation screen 20 on the administrator device 3.

### (3-3) Workflow Registration Processing

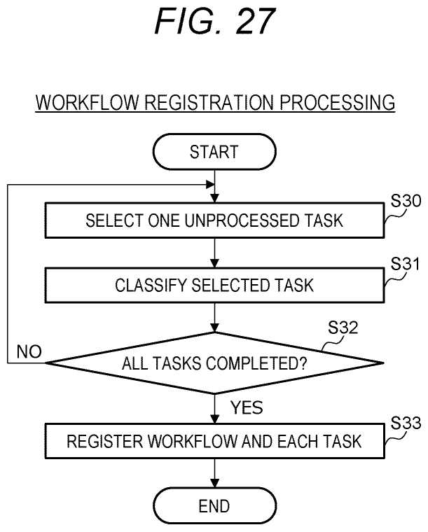

On the other hand, FIG. 27 illustrates a processing procedure of the workflow registration processing executed by the operation management unit 58 in a case where the registration button 31 (FIGS. 2 to 7) is clicked after the administrator creates a new workflow by using the workflow creation screen 20. In accordance with the processing procedure illustrated in FIG. 27, the operation management unit 58 registers various types of information regarding the new workflow created by the administrator in the workflow table 52 (FIG. 20), the task table 50 (FIG. 18), and the task classification table 51 (FIG. 19).

In practice, when the registration button 31 is clicked after the administrator creates a new workflow by using the workflow creation screen 20, the operation management unit 58 starts the workflow registration processing illustrated in FIG. 27, and first, selects one task, which is not processed in step S31, among the tasks constituting the new workflow.

Subsequently, with the task selected in step S30 (hereinafter, in the description of FIG. 27, this is referred to as a selection task) as the classification target task, the operation management unit 58 classifies the selection task into any task classification by executing the task classification processing described above with respect to FIG. 25 (S31).

Next, the operation management unit 58 determines whether the processing of steps S31 to S33 has been executed for all the tasks of the new workflow to be registered (S32). Then, if a negative result is obtained in this determination, the operation management unit 58 returns to step S30, and thereafter, repeats the processing of steps S30 to S32 while sequentially switching the task selected in step S30 to another unprocessed task in step S31.

Then, if an affirmative result is obtained in step S32 by eventually completing the classification of all the tasks of the new workflow to be registered into any task classification, the operation management unit 58 newly registers information regarding the new workflow to be registered in the workflow table 52, and newly registers task information of each task constituting the new workflow in the task table 50 (S33).

However, at this time, in a case where the completely same past case workflow as the new workflow to be registered has already been registered in the workflow table 52, the operation management unit 58 does not register the new workflow in the workflow table 52. Similarly, in a case where a task in which the parameter values of all the parameters are completely matched with those of the task already registered in the task table 50 exists among the tasks constituting the new workflow to be registered, the operation management unit 58 does not register the task in the task table 50.

Thereafter, the operation management unit 58 ends the workflow registration processing.

### (3-4) Workflow Time/Cost Prediction Processing

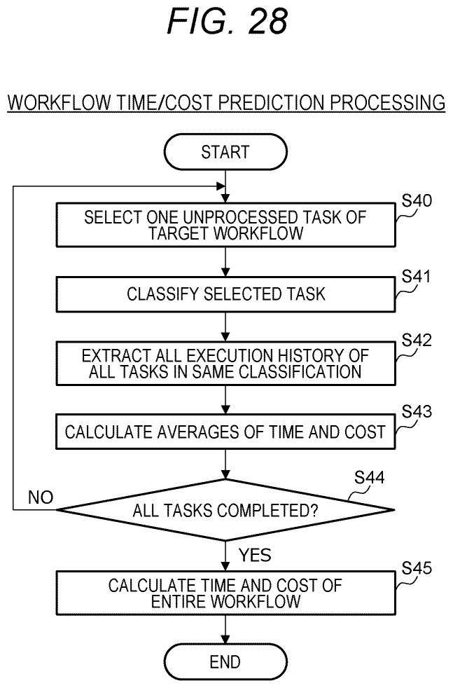

FIG. 28 illustrates a processing procedure of the workflow time/cost prediction processing executed by the operation management unit 58 to predict the execution time of the workflow and the execution cost of the workflow.

For example, in a case where the analysis button 28 (FIGS. 2 to 7) is clicked after the administrator creates a new workflow by using the workflow creation screen 20, the operation management unit 58 starts the workflow time/cost prediction processing illustrated in FIG. 28.

Then, the operation management unit 58 first selects one unprocessed task after step S41 among the tasks of a workflow to be targeted (hereinafter, this is referred to as a target workflow) (S40). In addition, by executing the task classification processing described above with respect to FIG. 25 for the selected task (hereinafter, in the description of FIG. 28, this is referred to as a selection task), the operation management unit 58 classifies the selection task into any task classification.

Subsequently, the operation management unit 58 extracts all the execution histories of the tasks classified into the same task classification as the selection task from the task execution history table 56 (FIG. 24) (S42). Specifically, the operation management unit 58 specifies, among the records of the task table 50, all records in which the task classification IDs of the same task classification as that of the selection task are stored in the task classification ID field 50B, and extracts all the task IDs stored in the task IDs of these records. Then, the operation management unit 58 extracts, from the task execution history table 56, all pieces of information of records in which any task ID among the task IDs extracted as described above is stored in the task ID field 56 C among the records of the task execution history table 56.

Next, the operation management unit 58 calculates an average value of the execution times of the tasks and an average value of the execution costs of the tasks from the execution histories of the tasks extracted in step S42 (S43). Specifically, the operation management unit 58 calculates an average value of the execution times of the tasks included in the execution histories of the tasks acquired in step S42. In addition, the operation management unit 58 calculates an average value of the execution costs of these tasks included in the execution history of the tasks acquired in step S42.

At this time, for the task in which the cost manual input value (the value stored in the cost manual input value field 56F in FIG. 24) is registered among the tasks for which the execution history is acquired in step S42, the operation management unit 58 uses the cost manual input value as the execution cost of the task, and for the task in which the cost manual input value is not registered, the operation management unit uses the cost automatic calculation value (the value stored in the cost automatic calculation value field 56E in FIG. 24) as the execution cost of the cost.

Thereafter, the operation management unit 58 determines whether the processing of steps S41 to S43 has been executed for all the tasks of the target workflow (S44). Then, if a negative result is obtained in this determination, the operation management unit 58 returns to step S40, and thereafter, repeats the processing of steps S40 to S44 while sequentially switching the task selected in step S40 to an unprocessed task after step S41.

Then, when an affirmative result is obtained in step S44 by eventually completing the calculation of the average values of the execution time and the execution cost of the task in the execution history for all the tasks of the target workflow, the operation management unit 58 calculates the predicted values of the execution time and the execution cost of the entire target workflow by adding up the average values of the execution time and the execution cost of each task of the target workflow calculated so far (S45). Thereafter, the operation management unit 58 ends the workflow time/cost prediction processing.

### (3-5) Workflow Analysis Processing

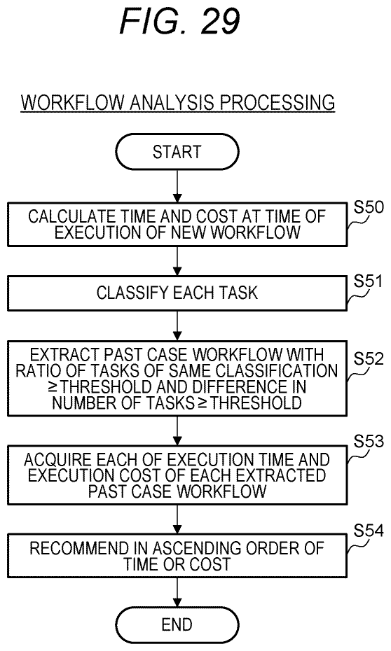

FIG. 29 illustrates a flow of workflow analysis processing executed by the operation management unit 58 when the workflow creation support device 2 analyzes a new workflow created by using the workflow creation screen 20 and presents another recommended workflow to the administrator.

When the analysis button 28 (FIGS. 2 to 7) is clicked after a new workflow is created on the workflow creation screen 20, the operation management unit 58 starts the workflow analysis processing illustrated in FIG. 28.

Then, the operation management unit 58 first executes the workflow time/cost prediction processing described above with respect to FIG. 28 with the new workflow as the target workflow, thereby calculating the predicted values of the execution time and the execution cost of the new workflow (S50).

Subsequently, by executing the task classification processing described above with respect to FIG. 25 for each of the tasks of the new workflow the operation management unit 58 classifies each of the tasks into any task classification (S51).

Next, the operation management unit 58 extracts, from the past case workflow, all past case workflows in which a ratio of tasks having the same task classification as the task classification of each task of the new workflow to the entire tasks of the past case workflow is equal to or larger than a predetermined first threshold, and a difference between the number of tasks (the number of steps) in the new workflow and the number of tasks (the number of steps) in the past case workflow is equal to or smaller than a preset second threshold (S52).

Next, the operation management unit 58 acquires, from the workflow execution history table 55, the execution time and the execution cost of each past case workflow extracted in step S52 (S53). At this time, in a case where the execution cost is stored in the corresponding total cost manual input value field of the workflow execution history table 55, the execution cost is acquired.

Then, on the basis of the execution time and the execution cost of each past case workflow acquired in step S53, the operation management unit 58 notifies the screen creation unit 57 of the top several past case workflows having the shortest execution time or the top several past case workflows having the lowest execution cost among these past case workflows (S54).

As a result, the workflow creation screen 20 in which the display is made in the recommendation area 20B in the ascending order of the execution time or the execution cost is generated by the screen creation unit 57, and the screen data is transmitted to the corresponding administrator device 3, whereby the workflow creation screen 20 is displayed on the administrator device 3.

Thereafter, the operation management unit 58 ends the workflow analysis processing.

### (4) Flow of Various Types of Processing

Next, a flow of various types of processing executed in the entire workflow creation support system 1 in relation to the above-described workflow creation support function will be described.

### (4-1) Creation/Registration of Workflow

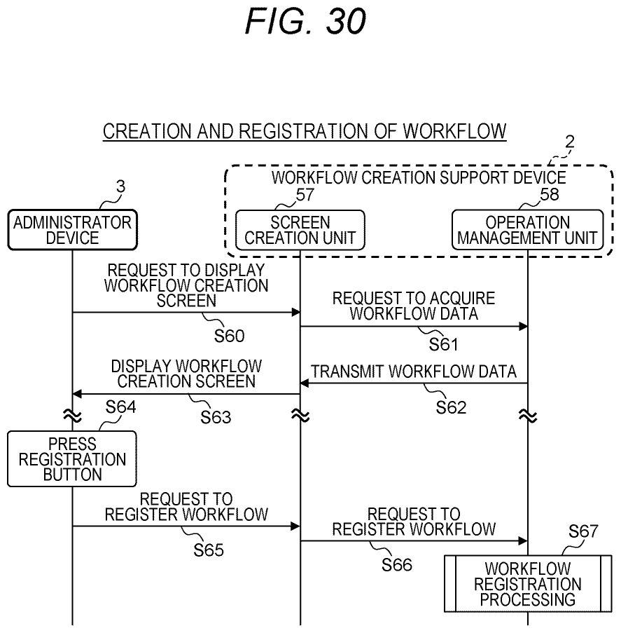

FIG. 30 illustrates a flow of a series of processing executed in the workflow creation support system 1 until the administrator creates a new workflow by using the workflow creation screen 20 and registers the created new workflow in the workflow creation support device 2.

When the administrator performs a predetermined operation for displaying the workflow creation screen 20 on the administrator device 3, a workflow creation screen display request is transmitted from the administrator device 3 to the workflow creation support device 2 (S60).

Then, the screen creation unit 57 of the workflow creation support device 2 that has received the workflow creation screen display request transfers a workflow data acquisition request to the operation management unit 58 (S61). In addition, in a case where there is a new workflow being created, the operation management unit 58 that has received the workflow acquisition request transmits, as workflow data, workflow information up to that time of the new workflow to the screen creation unit 57, and in a case where there is no new workflow being created, the operation management unit notifies the screen creation unit 57 of the fact (S61).

In a case where the workflow data is received, on the basis of the workflow data, the screen creation unit 57 generates a workflow creation screen 20 in which a new workflow being created is displayed in the workflow creation area 20A, and transmits the screen data of the generated workflow creation screen 20 to the administrator device 3. As a result, the workflow creation screen 20 is displayed on the administrator device 3. In addition, in the case of receiving the notification that there is no new workflow being created, the screen creation unit 57 transmits the screen data of the workflow creation screen 20 in an initial state to the administrator device 3. As a result, the workflow creation screen 20 in the initial state is displayed on the administrator device 3 (S63).

Thereafter, according to the operation 1 of the administrator, the screen transition of the workflow creation screen 20 described above with respect to FIGS. 2 to 7 is performed by the cooperative processing of the screen creation unit 57 and the operation management unit 58 of the workflow creation support device 2. Then, when the administrator eventually completes the creation of the new workflow and clicks the registration button 31 (FIGS. 2 to 7) on the workflow creation screen 20 (S64), a workflow registration request is transmitted from the administrator device 3 to the workflow creation support device 2 (S65).

Then, the screen creation unit 57 of the workflow creation support device 2 that has received the workflow registration request transfers the received workflow registration request to the operation management unit 58 (S66). In addition, the operation management unit 58 that has received the workflow registration request registers information regarding the new workflow in the workflow table 52 by executing the workflow registration processing described above with respect to FIG. 27, and registers task information of each task of the new workflow in the task table 50 (FIG. 18) (S67). As described above, this series of processing ends.

### (4-2) Recommendation of Task

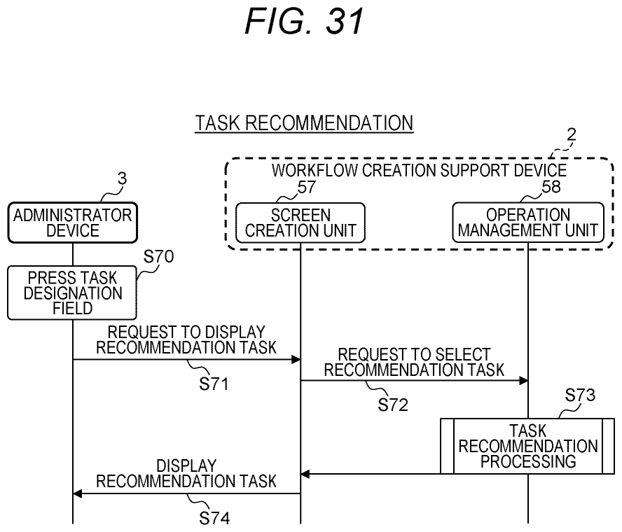

FIG. 31 illustrates a flow of a series of processing executed in the workflow creation support system 1 in a case where the administrator clicks any task setting field 21 (FIGS. 2 to 7) displayed in the workflow creation area 20A of the workflow creation screen 20 when creating a new workflow with the flow described above with respect to FIGS. 2 to 7 by using the workflow creation screen 20 displayed on the administrator device 3 in step S63 of the series of processing described above with respect to FIG. 30.

In the workflow creation support system 1, tasks to be recommended to the administrator are selected in the following flow illustrated in FIG. 31, and the icons 24 (FIGS. 3, 4, and 6) indicating the labels of these tasks are displayed in the recommendation area 20B of the workflow creation screen 20.

In practice, when the administrator clicks the task setting field 21 of any step after the third step in the new workflow displayed in the workflow creation area 20A of the workflow creation screen 20 (S70), a recommendation task display request for requesting display of a task to be recommended as a task of the step is transmitted from the administrator device 3 to the workflow creation support device 2 (S71).

The screen creation unit 57 of the workflow creation support device 2 that has received the recommendation task display request transmits, to the operation management unit 58, a recommendation task selection request for requesting selection of a task to be recommended as the task of the step (hereinafter, in the description of FIG. 31, this is referred to as a target step) in which the task setting field 21 is clicked at that time (S72).

The operation management unit 58 that has received the recommendation task selection request selects a task to be recommended by executing the task recommendation processing described above with respect to FIG. 26, and transmits necessary information such as the title of each selected task and the above-described evaluation value S to the screen creation unit 57 (S73).

Then, the screen creation unit 57 that has received the information of the tasks generates the workflow creation screen 20 in which the icons 24 indicating the label of the tasks to be recommended selected by the operation management unit 58 are arranged in the recommendation area 20B as described above with respect to FIG. 3, and transmits the screen data to the administrator device 3 (S74). As a result, the workflow creation screen 30 is d displayed on the administrator device 3. As described above, this series of processing ends.

### (4-3) Analysis of Workflow

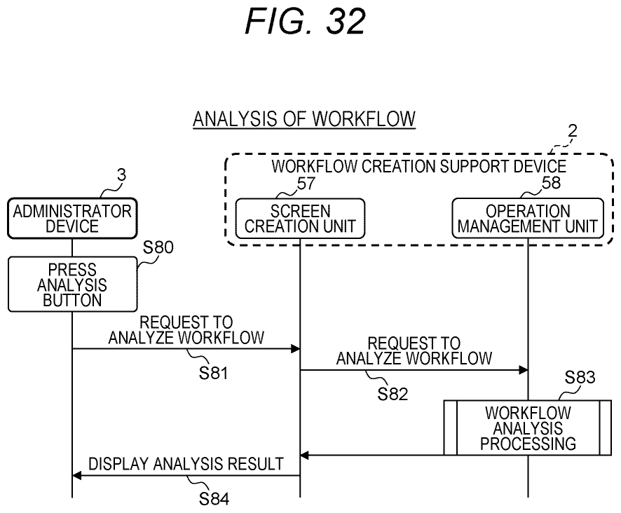

FIG. 32 illustrates a flow of a series of processing executed in the workflow creation support system 1 in a case where the administrator clicks the analysis button 28 (FIGS. 2 to 7) of the workflow creation screen 20 after creating a new workflow with the flow described above with respect to FIGS. 2 to 7 by using the workflow creation screen 20 displayed on the administrator device 3 in step S63 of the series of processing described above with respect to FIG. 30. In the workflow creation support system 1, analysis processing for the new workflow created at that time is executed in the following flow illustrated in FIG. 32.

In practice, when the administrator clicks the analysis button 28 after creating a new workflow on the workflow creation screen 20 (S80), a workflow analysis request for requesting analysis of the new workflow is transmitted from the administrator device 3 to the workflow creation support device 2 (S81). In addition, the screen creation unit 57 of the workflow creation support device 2 that has received the workflow analysis request transfers the workflow analysis request to the operation management unit 58 (S82).

Then, the operation management unit 58 that has received the workflow analysis request executes the workflow analysis processing described above with respect to FIG. 29 (S83). As a result, the predicted values of the execution time and the execution cost of the new workflow are calculated, the recommended workflow is extracted from the past case workflow, and the calculated execution time and execution cost and the information regarding the extracted recommended workflow are transmitted as an analysis result to the screen creation unit 57.

When the analysis result is given from the operation management unit 58, the screen creation unit 57 generates the workflow creation screen 20 described above with respect to FIG. 7 in which the predicted values of the execution time and the execution cost of the new workflow are displayed in the workflow creation area 20A and the recommended workflow 30 (FIG. 7) is displayed in the recommendation area 20B, and transmits the screen data to the administrator device 3 (S84). As a result, the workflow creation screen 20 is displayed on the administrator device 3. As described above, this series of processing ends.

### (4-4) Writing of New Workflow

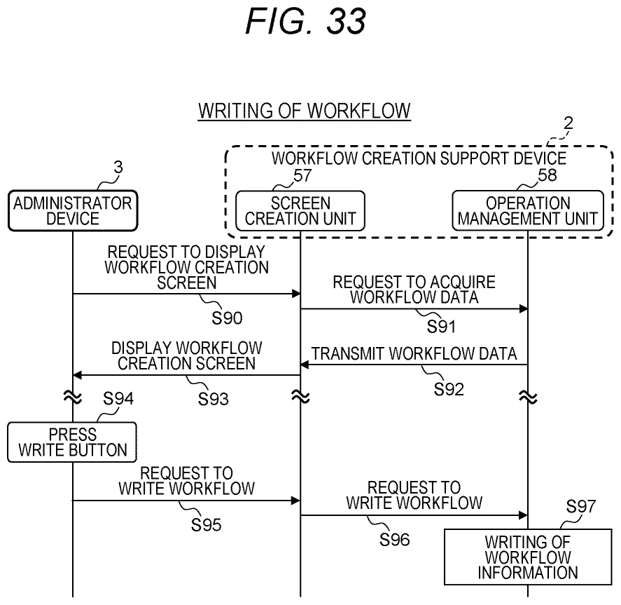

FIG. 33 illustrates a flow of a series of processing executed in the workflow creation support system 1 until the administrator creates a new workflow by using the workflow creation screen 20 and writes the created new workflow. Note that, in FIG. 33, the processing of steps S90 to S93 is similar to the processing of steps S60 to S63 in FIG. 30, and thus description thereof is omitted here.

When the administrator clicks the write button 32 (FIGS. 2 to 7) after creating a new workflow by using the workflow creation screen 20 (S94), a workflow write request for requesting writing of the new workflow created at that time is transmitted from the administrator device 3 to the workflow creation support device 2 (S95). In addition, the screen creation unit 57 of the workflow creation support device 2 that has received the workflow write request transfers the workflow write request to the operation management unit 58 (S96).

Then, the operation management unit 58 that has received the workflow write request delivers the workflow information of the new workflow to the procedure file management unit 60 (FIG. 1) (S97). Thus, the procedure file management unit 60 to which the workflow information has been delivered converts the flowchart information into a file and stores the file data of the file in the auxiliary storage device 12 (FIG. 1). As described above, this series of processing ends.

### (4-5) Execution of Workflow

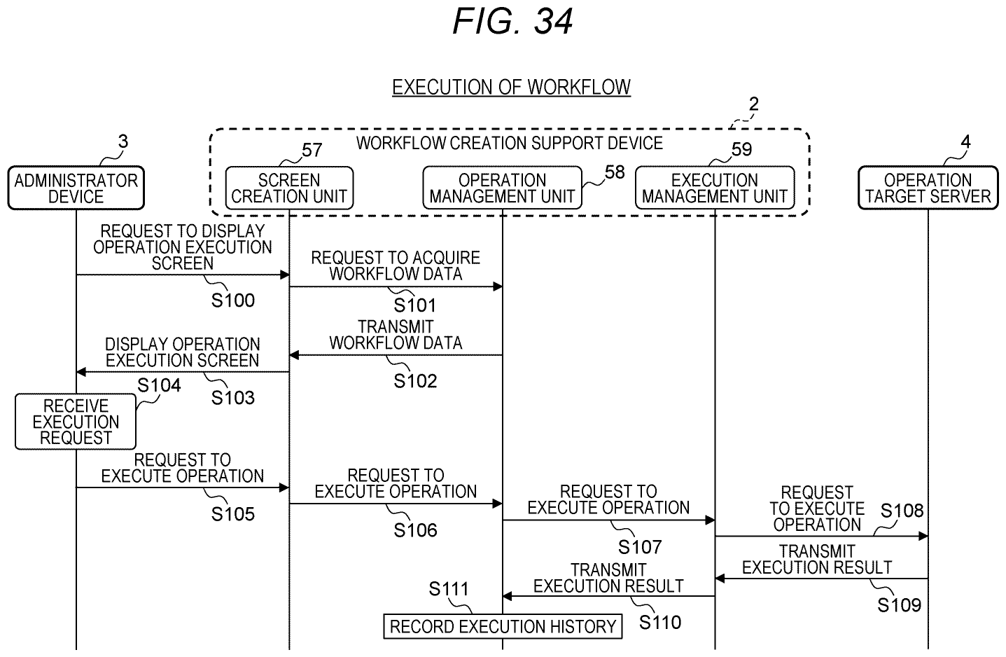

FIG. 34 illustrates a flow of a series of processing when the administrator causes a desired workflow to be executed in the desired operation target server 4.

First, when the administrator designates a desired workflow and performs a predetermined operation for displaying a predetermined operation execution screen (not illustrated), an operation execution screen display request is transmitted from the administrator device 3 to the workflow creation support device 2 (S100). Note that the operation execution screen display request also includes the workflow ID of the workflow designated by the administrator at that time.

Then, the screen creation unit 57 of the workflow creation support device 2 that has received the workflow creation screen display request transmits, to the operation management unit 58, a workflow data acquisition request for requesting acquisition of data of the workflow to be executed included in the operation execution screen request (S101).

In addition, the operation management unit 58 that has received the workflow acquisition request refers to the task list field 52B (FIG. 20) of the workflow table 52 (FIG. 20) to acquire each task constituting the requested workflow and acquires the acquired task information of each task from the task table 50 (FIG. 18), and transmits these pieces of information as workflow data to the screen creation unit 57 (S102). As a result, the workflow designated by the administrator is displayed on the administrator device 3.

Thereafter, the administrator designates, on the operation execution screen, the operation target server 4 on which the workflow is to be executed, and instructs, on the operation execution screen, execution of the workflow on the operation target server 4. Then, when this instruction is received by the administrator device 3 (S104), an operation execution request indicating that the workflow is to be executed by the target server is transmitted from the administrator device 3 to the workflow creation support device 2 (S105).

In addition, the screen creation unit 57 of the workflow creation support device 2 that has received the operation record request transfers the received operation execution request to the operation management unit 58 (S106), and the operation management unit 58 that has received the operation execution request transfers the operation execution request to the execution management unit 59 (S107).

When receiving the operation execution request, on the basis of the operation execution request, the execution management unit 59 transmits the workflow information of the workflow and an operation execution command indicating that the workflow is to be executed, to the operation target server 4 designated on the operation execution screen by the administrator (S108).

Thus, the workflow is executed in the operation target server 4 that has received the operation execution command. Then, when the operation target server 4 ends executing the workflow, the operation target server 4 transmits the execution result to the workflow creation support device 2 (S109).

In addition, the execution management unit 59 of the workflow creation support device 2 that has received the execution result transfers the received execution result to the operation management unit 58 (S110). Thus, the operation management unit 58 that has received the execution result stores necessary information including the time and cost required to execute the workflow automatically calculated for the entire workflow and the time and cost required to execute the task automatically calculated for each task constituting the workflow in the workflow execution history table 55 (FIG. 23) and the task execution history table 56 (FIG. 24), respectively (S111). As described above, this series of processing ends.

### (4-6) Operation Status Confirmation

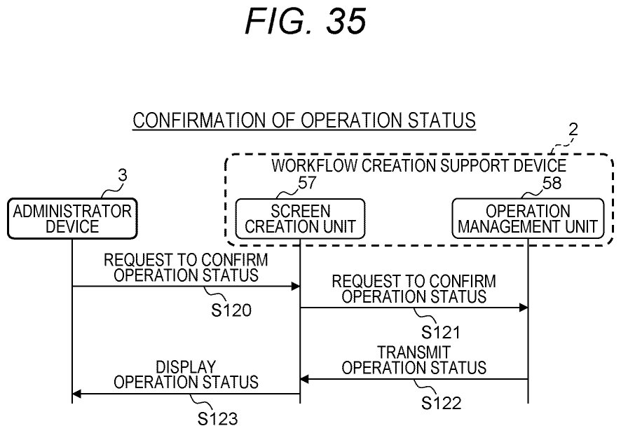

FIG. 35 illustrates a flow of a series of processing when the execution status of the workflow performed or being performed in the operation target server 4 is displayed on the administrator device 3 in response to a request from the administrator. Note that as a premise of this processing, it is assumed that the operation target server 4 executing the workflow notifies the workflow creation support device 2 of the execution result every time one task of the workflow is completed, and the operation management unit 58 manages this notification.

In this case, first, when the administrator performs a predetermined operation on the administrator device 3, an operation status confirmation request is given from the administrator device 3 to the screen creation unit 57 of the workflow creation support device 2 in response to the predetermined operation (S120). In addition, when receiving the operation status notification request, the screen creation unit 57 transmits the operation status notification request to the operation management unit 58 (S121).

When receiving the operation status confirmation request, the operation management unit 58 transmits, to the screen creation unit 57, the execution result of each task given so far from the operation target server 4 with respect to the execution of the workflow to be targeted (S122). In addition, the screen creation unit 57 displays the execution result of each task given from the operation management unit 58 on the administrator device 3 (S123). As described above, this series of processing ends. (4-7) Manual registration of operation record

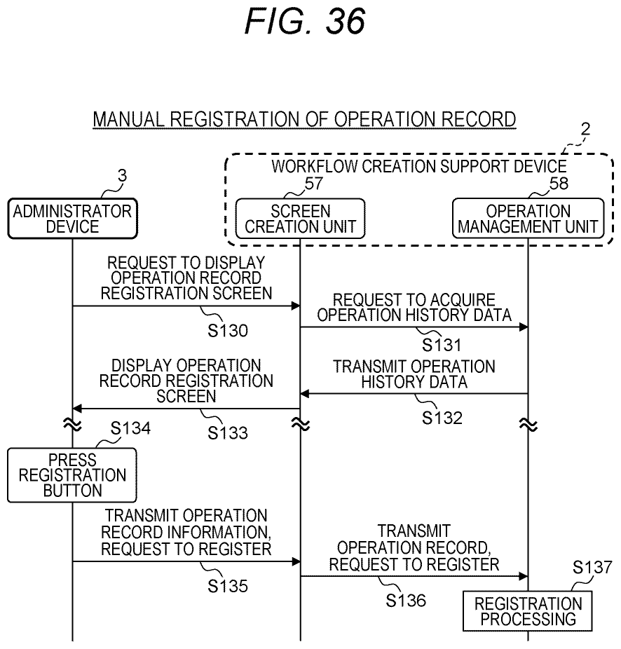

FIG. 36 illustrates a flow of a series of processing when the administrator manually registers the operation record of the workflow performed in the target server.

In this case, when the administrator designates the past case workflow to be targeted and then performs a predetermined operation on the administrator device 3 to display the operation record registration screen 40 described above with respect to FIG. 8, an operation record registration screen display request indicating that the operation record registration screen 40 is to be displayed is transmitted from the administrator device 3 to the screen creation unit 57 of the workflow creation support device 2 (S130). Note that the operation record registration screen display request also includes the workflow ID of the workflow to be targeted designated by the administrator at that time and the workflow execution history ID of the workflow.

When receiving the operation record registration screen display request, the screen creation unit 57 transmits, to the operation management unit 58, an operation history data acquisition request indicating that the operation history data of the workflow to be targeted designated in the operation record registration screen display request is to be transferred (S131).

When the operation history data acquisition request is given from the screen creation unit 57, the operation management unit 58 transmits the operation history data of the workflow to be targeted to the screen creation unit 57 (S132). Specifically, the operation management unit 58 acquires a list (task list) of tasks constituting the workflow to be targeted from the task list field 52B (FIG. 20) of the corresponding record in the workflow table 52 (FIG. 20), and acquires a label of each task included in the acquired task list from the task table 50 (FIG. 18). In addition, the operation management unit 58 transmits the acquired task list and the level of each task as operation history data to the screen creation unit 57.

The screen creation unit 57 that has received the operation history data generates the operation record registration screen 40 described above with respect to FIG. 8 on the basis of the received operation history data, and transmits the screen data to the administrator device 3 (S133). As a result, the operation record registration screen 40 is displayed on the administrator device 3.

Thereafter, when the administrator manually inputs the execution time of the workflow, the name of a person in charge, a total cost, and the like and then clicks the registration button 47 (FIG. 8) (S134), the administrator device 3 transmits, as operation record information, the various types of information input at this time to the workflow creation support device 2 together with a registration request (S135). In addition, the screen creation unit 57 of the workflow creation support device 2 that has received the operation record information and the registration request transfers the operation record information and the registration request to the operation management unit 58 (S136).

Thus, the operation management unit 58 that has received the operation record information and the registration request stores various types of information included in the operation record information in the total cost manual input value field 55E (FIG. 23) of the corresponding record of the workflow record history table 55 (FIG. 23) and the total cost manual input value field 56F (FIG. 24) of the corresponding record of the task execution history table 56 (FIG. 24) (S137). As described above, this series of processing ends.

### (5) Effects of Present Embodiment

As described above, on the basis of the workflow information and the execution history of the past case workflow and the task information and the execution history of each task constituting the past case workflow, the workflow creation support device 2 of the present embodiment extracts a candidate of a step designated in the new workflow from the tasks of the past case, and recommends the extracted task as a task of the step.

Therefore, according to the present workflow creation support device 2, it is possible to recommend an appropriate task that has already been defined to the administrator who is creating the workflow, and thus it is possible to reduce labor and time required for creating the workflow.

### (6) Other Embodiments

Note that, in the above-described embodiment, a case has been described in which the workflow creation support device 2 is configured by one computer device, but the present invention is not limited thereto, and the workflow creation support device 2 may be configured by a plurality of computer devices constituting a distributed computing system.

In addition, in the above-described embodiment, a case has been described in which a task of a certain step is set by a predetermined operation on the workflow creation screen 20, and the task setting field 21 of the next step is automatically displayed when the icon 22 indicating the label of the task is displayed in the task setting field 21, but the present invention is not limited thereto, and a dedicated button for displaying the task setting field 21 may be provided, and the task setting field 21 of the next step may be displayed by clicking the button.

Furthermore, in the above-described embodiment, a case has been described in which the processing of steps S15 to S19 is executed after r steps S10 to S14 in the task recommendation processing described above with respect to FIG. 26, but the present invention is not limited thereto, and the processing of steps S10 to S14 and steps S15 to S19 may be simultaneously performed in parallel.

### INDUSTRIAL APPLICABILITY

The present invention can be widely applied to various workflow creation support devices that support creation of a workflow including a plurality of tasks.

### REFERENCE SIGNS LIST

1 workflow creation support system
2 workflow creation support device
3 administrator device
4 operation target server
10 CPU
20 workflow creation screen
21 task setting field
22, 24 icon
26 first pop-up
27 second pop-up
28 analysis button
29 third pop-up
31, 47 registration button
32 write button
40 operation record registration screen
42 execution time text box
43 cost text box
44 person-in-charge text box
45A cost difference reason designation field 45A
46 fourth pop-up
50 task table
51 task classification table
52 workflow table
53 person-in-charge table
54 cloud execution environment table
55 workflow execution history table
56 task execution history table
57 screen creation unit
58 operation management unit
59 execution management unit
60 procedure file management unit

1. A workflow creation support device that supports creation of a workflow including a plurality of tasks, the workflow creation support device comprising:
a management unit that manages definition contents of a workflow created in past; and
a candidate task recommendation unit that extracts and recommends a task candidate of a step to be targeted in the workflow being created, on a basis of definition contents of a predetermined number of steps of previous and/or subsequent tasks already defined in the workflow being created and definition contents of the existing workflow managed by the management unit.

2. The workflow creation support device according to claim 1, wherein
the candidate task recommendation unit
classifies each of previous and/or subsequent tasks of each step already defined in the workflow being created into any of task classifications,
extracts the existing workflow in which tasks of a same task classification exist in a same order,
specifies a task classification of a task of a step to be targeted in each extracted existing workflow, and
recommends a task of a task classification having a higher appearance probability as a task candidate of a step to be targeted in the workflow being created, on a basis of an appearance probability of each specified task classification.

3. The workflow creation support device according to claim 2, wherein
the task is defined by a plurality of types of parameters,
the parameters of the task are managed to be divided into
a first parameter group that is determined to be same in an exact match, a second parameter group in which similar ones are treated as same, and a third parameter group other than the parameters belonging to the first and second parameter groups, and
the candidate task recommendation unit
classifies a task into a task classification in which values of parameters belonging to the first parameter group are completely matched with each other and the parameters belonging to the second parameter group are similar to each other among existing task classifications.

4. The workflow creation support device according to claim 2, wherein
the candidate task recommendation unit
extracts all tasks of a task classification having a higher appearance probability from each of the existing workflows, evaluates the extracted tasks on a basis of an appearance frequency, an execution time, and an execution cost of the task, and recommends a predetermined number of top tasks having a large evaluation value as task candidates of a step to be targeted in the workflow being created.

5. The workflow creation support device according to claim 1, wherein
a new workflow is able to be created by sequentially designating a task of each step of the workflow on a predetermined screen, and
the candidate task recommendation unit
recommends each task candidate by displaying, on the predetermined screen, an icon corresponding to each of the task candidates of a step to be targeted in the workflow being created.

6. A workflow creation support method executed by a workflow creation support device that supports creation of a workflow including a plurality of tasks, the workflow creation support method comprising:
a first processing step of managing definition contents of a workflow created in past; and
a second processing step of extracting and recommending a task candidate of a step to be targeted in the workflow being created, on a basis of definition contents of a predetermined number of steps of previous and/or subsequent tasks already defined in the workflow being created and definition contents of the existing workflow being managed.

7. The workflow creation supporting method according to claim 6, wherein
in the second processing step, the workflow creation support device
classifies each of previous and/or subsequent tasks of each step already defined in the workflow being created into any of task classifications,
extracts the existing workflow in which tasks of a same task classification exist in a same order,
specifies a task classification of a task of a step to be targeted in each extracted existing workflow, and
recommends a task of a task classification having a higher appearance probability as a task candidate of a step to be targeted in the workflow being created, on a basis of an appearance probability of each specified task classification.

8. The workflow creation supporting method according to claim 7, wherein
the task is defined by a plurality of types of parameters,
the parameters of the task are managed to be divided into
a first parameter group that is determined to be same in an exact match, a second parameter group in which similar ones are treated as same, and a third parameter group other than the parameters belonging to the first and second parameter groups, and
in the second processing step, the workflow creation support device
classifies a task into a task classification in which values of parameters belonging to the first parameter group are completely matched with each other and the parameters belonging to the second parameter group are similar to each other among existing task classifications.

9. The workflow creation supporting method according to claim 7, wherein
in the second processing step, the workflow creation support device
extracts all tasks of a task classification having a higher appearance probability from each of the existing workflows, evaluates the extracted tasks on a basis of an appearance frequency, an execution time, and an execution cost of the task, and recommends a predetermined number of top tasks having a large evaluation value as task candidates of a step to be targeted in the workflow being created.

10. The workflow creation supporting method according to claim 6, wherein
a new workflow is able to be created by sequentially designating a task of each step of the workflow on a predetermined screen, and
in the second processing step, the workflow creation support device
recommends each task candidate by displaying, on the predetermined screen, an icon corresponding to each of the task candidates of a step to be targeted in the workflow being created.
